(19) United States
(12) Patent Application Publication
(10) Pub. No.: US 2006/0007406 A1
(43) Pub. Date: Jan. 12, 2006

(54) Equipment, systems and methods for control of color in projection displays

(76) Inventors: Sean Adkins, Vancouver (CA); Michael Gibbon, Oakville (CA)

Correspondence Address: JOHN S. PRATT, ESQ;KILPATRICK STOCKTON, LLP, 1100 PEACHTREE STREET, ATLANTA, GA, 30309, US

(21) Appl. No.: 10/531,778

(22) PCT Filed: Oct. 21, 2002
(86) PCT No.: PCT/US02/33546

§ 371 Date: Apr. 19, 2005

(51) Int. Cl. G03B 21/14

(52) U.S. Cl. 353/82

(57) ABSTRACT

The present invention discloses systems, equipment and methods that allow the improved adjustment of color in projection displays. Equipment, systems and methods are disclosed for matching the color balance of each display including the color of the display primaries and further equipment, systems and methods are disclosed for the correction of a field dependant color variation across the field of an SLM based projector.

### FIELD OF THE INVENTION

This invention relates to the projection of images and more specifically to methods and equipment for matching the color between projection displays.

### BACKGROUND OF THE INVENTION

Spatial Light Modulator (SLM) based projection displays are often used in applications where the reduction of color variation in a display and the matching of colors between displays is important. Displays used in the presentation of high quality images, such as for motion picture applications, require good color matching since the control of color is an important part of the expressive dimension of the film images. Users of these displays desire that in every theatre the colors reproduced by the projection system should match those that were determined during the post production of the motion picture.

In other applications multiple displays may be used at the same time, for example when the spatial resolution of a single projection display system of a given type is inadequate. Multiple projection displays may also be required where the projection surface covers a large area or a surface of a shape that cannot be covered by a single projection display system with the desired brightness and image quality.

In such situations it is common to employ multiple projection displays in a tiled arrangement. Two or more projection displays are arranged so that their images are adjacent and form a matrix of horizontal and vertical elements so that the resulting composite image has a higher resolution and brightness than would result if a single projection display were used to cover the same projection surface area. Subdivision of the display also allows the projection surface to change in shape or distance from the projection points without requiring excessive depth of focus or special distortion correction from the projection lenses. Multiple displays may also be fully superimposed upon each other to obtain increased brightness or other benefits from the combination of superimposed images such as the suppression of sampling artifacts. In order for these arrangements of multiple displays to have maximum image quality the color characteristics of each of the projectors should be well matched.

Projection displays based on spatial light modulators (SLMs) such as deformable mirror devices (DMDs) commonly employ multiple SLMs in order to produce a color display using additive means based on three primary colors. These systems frequently use so-called dichroic filter elements to divide the light from the illuminating light source into three spectral bands that correspond to the desired primary colors, conventionally red, green and blue. Three SLM devices are then used one for each primary color, to modulate the intensity of the divided light, which is then recombined into a single beam and projected onto the display screen by the projection lens. The SLM devices are driven by an input signal that conveys the brightness for each pixel of each of the three SLM devices so that the desired continuous tone color image is formed on the display screen.

In order to produce an image with uniform and consistent color, the characteristics of the dichroic color filters should be very carefully matched. In addition, the angle of illumination for each of the filters should be very carefully controlled due to the fact that the wavelengths of the dichroic filter's passband depend on the angle of incidence. It is difficult to precisely control the color balance of displays equipped with dichroic filters due to the angle dependent nature of the filter characteristics and the inevitable manufacturing tolerances that arise in any mass produced system. Usually these filters are contained within an optical combining assembly that does not permit selection or adjustment of the filters for reasons of practicality and stability. As a result such displays can exhibit color shifts across the display such that, for example, an input signal representing a uniform white field is displayed with a slightly bluish tint at one edge, and a slightly reddish tint at the other edge.

Projection displays based on SLM devices commonly employ electronic circuitry to permit control of the appearance of the image. These controls include a means for adjusting the overall contrast or gain, black level, tint and saturation of the display. It is also common for controls to be provided that adjust the gain and black level of each color channel separately. These controls are also commonly used to adjust the color balance of the display, for example to set the displayed white to a particular tint, and to ensure that a displayed grayscale has a neutral appearance. An additional means of adjusting the projector color channels may also be provided that consists of a look-up table that receives the input pixel values for each color channel and for each input pixel value outputs a new pixel value to the SLM devices. This look up table may be used to alter the relative brightness of each channel as well as the input pixel value to image pixel brightness transfer function of each channel.

The color balance of an additive display can therefore be adjusted by altering the relative brightness of each channel of the display. However, this color adjustment is achieved by reducing the maximum brightness of one or more of the color channels of the display which in turn reduces the maximum brightness of the display. Furthermore, achieving a desired overall color balance for a group of displays in a multiple projection display configuration may require lowering the brightness of all of one or more of the red, green and blue channels of all of the multiple projection displays, further reducing the brightness of the composite display.

Second, adjusting color shift and color balance by manipulating the relative brightness of the three primaries is only effective in the general case for displayed colors that contain some proportion of all three of the primaries. Saturated colors or colors that contain only one or two of the three primaries cannot in general be matched between displays by adjusting the brightness of the red, green and blue components of each display.

An improvement in color matching can be obtained by mapping input colors to display colors using for example a three dimensional matrix operation or a three dimensional look-up table. However, this method of matching colors between two or more displays requires that the displayed colors fall within the common gamut of all of the displays. This has the effect of reducing the gamut of colors that can be displayed. This is shown for example in U.S. patent application 2002/0041708 A1 to Pettitt. This patent application shows a method for matching multiple projectors to a “standard color gamut” which is of necessity a subset of the gamuts of the projectors to be matched as shown in FIG. 5 of the application. While Pettitt makes use of matrix methods to map input signal colors to specific brightness values for each color channel of the projector, a three dimensional look up table that maps input values to new values to be supplied to the SLM devices for the three channels would also suffice. Systems such as Pettitt that perform color correction by modifying the pixel brightness values supplied to the SLM devices in the projector can only match colors which are desaturated by the addition some of each of the other two primaries.

Finally, the adjustment of the brightness of the projector display channels cannot compensate for color shifts across the display since the adjustment acts equally on all pixels of the display.

U.S. Pat. No. 5,386,253 to Fielding describes a method for improving the uniformity of the projected image in a SLM based projection display. In Fielding, a sensor observing the far field is used to measure the brightness of regions of the projected image and this information is used to correct the brightness distribution on the screen by modifying the pixel brightness values supplied to regions of pixels of the SLM. This modification in pixel brightness may be used to alter the brightness of regions of the projected image to achieve the appearance of any desired brightness distribution. The method in Fielding cannot increase the brightness of a given region or area of the screen above that available for that given area in the uncorrected system. As a result, modifying the pixel brightness of areas of the projected image to achieve, for example, a flat field of uniform brightness will typically limit the brightness of the display to that of the least bright area of the projected image.

Fielding provides separate pixel value modifying means for each of three SLM devices used in a color projector. The method in Fielding is intended to ensure that the brightness of the pixels of each color channel of the projector is uniform. This reduces the effect of a color shift across the display, subject to the same limitation previously noted for overall color balance adjustments which is that such an adjustment is only generally effective for displayed colors that contain some proportion of all three of the primaries.

Fielding also makes reference to the fact that any overall gain adjustment applied to the pixel values in order to improve the overall uniformity of the display should be the same for all three color channels in order to avoid changing the color balance. It should be apparent to those skilled in the art that a different overall gain adjustment could be applied to the pixel values for each color channel, and that this adjustment essentially duplicates the color channel gain adjustments commonly provided in SLM based projectors.

U.S. Pat. No. 6,115,022 to Mayer, III et al. describes a method like that in Fielding where separate adjustment of the red, green and blue pixel values may be used to correct for color shifts in the displayed image. This method has several important limitations. First, as in Fielding the method cannot increase the brightness of the primary colors above that produced by an uncorrected system, only a reduction in brightness can be performed on each color channel. The correction of color shift in general requires reducing one or more of the red, green and blue pixel brightnesses in areas of the display where pixels are brighter to match the brightness in the areas where pixels are not as bright. Likewise the matching of adjacent displays by this method will result in additional reduction of brightness. Furthermore, achieving a desired overall color balance for the composite display may require lowering the brightness of all of the pixels in one or more of the red, green and blue channels of all of the multiple projection displays, further reducing the brightness of the composite display.

Second, adjusting color shift and color balance by manipulating the relative pixel brightnesses of the three primaries is only effective in the general case for displayed colors that contain some proportion of all three of the primaries. This means that saturated colors or colors that contain only two of the three primaries cannot in general be matched between displays by adjusting the pixel brightnesses of the red, green and blue components of each display.

Where methods such as Mayer, III et al. are applied to displays with high fundamental consistency such as CRT displays where the primary colors are determined by the phosphors used in the CRT and most of the color imbalance is electronic in origin, the likelihood is high that the primary colors will match. For the reasons given above this does not apply to SLM based displays where the three primary colors are produced by dichroic filters.

The prior art has not provided a solution that completely solves the problems of color uniformity and color shifts in the individual displays. In addition the methods of the prior art impose limitations on brightness and they are not effective in matching the primary colors of such displays.

As a result, the performance of SLM based projection displays is less than satisfactory due to color variations in the displays and the poor matching of the colors between projection displays.

### SUMMARY OF THE INVENTION

The present invention seeks to resolve these issues of uniformity and color matching by introducing equipment, systems and methods that allow for the control of the spectral energy distribution of the input light without reducing the overall brightness of the display. Equipment, systems and methods are disclosed that utilize secondary illumination sources, which add additional light, to reach the desired chromaticity for each primary color. Further equipment, systems and methods are disclosed that utilize adjustable bandpass filters in combination with the illumination source to control the amount of primary color in the input light in order to reach the desired chromaticity for each primary color. Further equipment, systems and methods are disclosed for the correction of field dependant color variation across the field of SLM based projectors.

### BRIEF DESCRIPTION OF THE DRAWINGS

FIG. 1 illustrates a projection system according to the prior art.

FIG. 2 is a diagram showing the color characteristics of SLM based projection displays according to the system of FIG. 1.

FIG. 3 is a more finely scaled diagram showing the color characteristics of SLM based projection displays according to the system of FIG. 1.

FIG. 4 is a graph of the shifts in the spectral transmission of a color filter used in the system of FIG. 1 as a result of changing the angle of incidence of the light reaching the filter.

FIG. 5 is a graph of the color differences in the display white point produced by changing the angle of incidence of the light reaching the filters used in the system of FIG. 1.

FIG. 6 shows the color gamuts produced by the color filters used in the system of FIG. 1.

FIG. 7 illustrates an exemplary embodiment of a system for reducing the color variation of the display and for adjusting the colors of each of the displays in the system of FIG. 1.

FIG. 8 shows graphs of the spectral energy distributions used for the secondary illumination sources in the systems of FIGS. 7, 9 and 10.

FIG. 9 illustrates another exemplary embodiment of a system for reducing the color variation of the display and for adjusting the colors of each of the displays in the system of FIG. 1.

FIG. 10 illustrates another exemplary embodiment of a system for reducing the color variation of the display and for adjusting the colors of each of the displays in the system of FIG. 1.

FIG. 11 illustrates the spectral energy distribution of a lamp used in the systems of FIGS. 9 and 10.

FIG. 12 is a diagram showing the color adjustment method of the inventions of FIGS. 7, 9 and 10.

FIG. 13 is a diagram showing the effect of varying the angle of incidence on the primary color filters in the system of FIGS. 7, 9 and 10.

FIG. 14 is a second diagram showing the effect of varying the angle of incidence on the primary color filters in the system of FIGS. 7, 9 and 10.

FIG. 15 is a block diagram of an apparatus for adjusting the brightness of a display based on the inventions of FIGS. 7, 9 and 10.

FIG. 16 is a block diagram describing an exemplary method for adjusting the colors of a display using the inventions of FIGS. 7, 9 and 10.

FIG. 17 is a diagram showing the effect of the invention of FIG. 7 in adjusting the colorimetry of the system in FIG. 1.

FIG. 18 is a graph showing the relative spectral powers of the illuminating light sources used in the system of FIG. 7 to make the color adjustments shown in FIG. 16.

FIG. 19 shows the adjusted color gamut for the system of FIG. 1 produced by the system of FIG. 7.

FIG. 20 is a graph showing the passbands of filters used in the green channel of the systems of FIGS. 7, 9 and 10 with an additional means of adjusting the color.

FIG. 21 is a graph showing the chromaticity coordinates of the primary and secondary illuminating light sources for the green channel of the systems of FIGS. 7, 9 and 10 with the filter passbands of FIG. 20.

FIG. 22 is a graph of the spectral transmission of three filters of the type used in the system of FIG. 1, showing the effects of wavelength shifts on the transmission of these filters.

FIG. 23 shows the effect of wavelength shift on the spectral transmission of a bandpass filter.

FIG. 24 shows an alternative system for adjusting the colors of a display system.

FIG. 25 is a diagram showing the effect of the invention of FIG. 24 in adjusting the colors of the system in FIG. 1.

FIG. 26 shows the spectral transmission of filters for use in an alternative filter arrangement for the system of FIG. 24.

FIG. 27 illustrates a method to adjust the field dependent color variation of a SLM based projector according to the present invention.

FIG. 28 is a detail of the method used in the invention of FIG. 27 in adjusting the field dependent color variation of the system in FIG. 1.

### DETAILED DESCRIPTION OF THE DRAWINGS

In order to improve the clarity of the description the present invention will be described using the example of two projectors used together to form a composite display where the two projected images are arranged side by side in the horizontal direction. This is a subset of a more complex system that may involve more than two projectors arranged in configurations where the composite image is produced from a matrix of images superimposed or arranged horizontally, vertically or both. It should be understood that the inventions disclosed herein may be applied to the more complex configurations and to the general application of adjusting the color of a projection display in the case where one display is used alone.

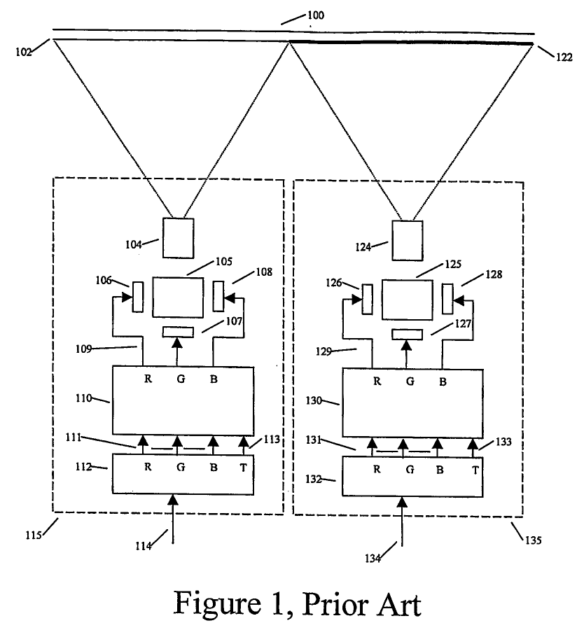

FIG. 1 illustrates in schematic form the plan view of a projection system using two SLM based projection displays to form a composite image according to the prior art. Various types of SLM devices may be employed including deformable mirror devices (DMDs), or reflective or transmissive liquid crystal devices, and in this example DMD type SLM devices are shown. The image to be displayed is divided into two halves, a left half and a right half, each being of the same height, but each being one half of the total width of the final image. The composite image is formed on display screen 100 which receives the left and right projected image halves from two projection systems, a left hand projector, 115 and a right hand projector 135. The left hand projector receives an image input signal corresponding to the left half of the desired image and the right hand projector receives an image input signal corresponding to the right half of the desired image.

Each projection system is identical and may be described in detail with reference to the left hand projector, 115, as follows. The numbers in parenthesis refer to the corresponding elements of the right hand projector, 135, in FIG. 1.

An input video or image data signal 114 (134) representing one half of the image to be displayed is supplied to input circuit 112 (132) which provides various facilities known to those skilled in the art for separation of composite inputs into discrete red, green and blue or “RGB” signal components as required by the input format, facilities to extract image frame timing information and facilities such as contrast control, color balance adjustment, image scaling and other features known to those skilled in the art. The output of circuit 112 (132) is three discrete signals 111 (131) corresponding to the three color components RGB of the image and a frame timing signal 113 (133). These signals are supplied to display control and formatting circuit 110 (130) which in turn supplies the control signals 109 (129) required by the SLM devices 106, 107 and 108 (126, 127 and 128). Each SLM device consists of a two dimensional array of modulating elements or pixels, and by means of various control signals each pixel modulates the intensity of a corresponding part of the light to be projected so as to form the desired pattern of pixel brightnesses that correspond to the image to be projected. Each SLM device corresponds to one of the three color components of the image to be displayed, and color separating and re-combining device 105 (125) provides the optical components necessary to filter input white light into three spectral color bands that correspond to the red, green and blue portions of the visible spectrum, this color separated light then illuminates SLM devices 106, 107 and 108 (126, 127 and 128) with red, green and blue light respectively. The control signals 109 (129) cause the individual picture elements to be controlled so as to modulate the intensity of the red, green or blue light falling on the SLM, which in turn is re-combined by color separating and re-combining device 105 (125) into a single image of overlaid red, green and blue components which is in turn projected by lens 104 (124) onto the screen 100. It will be known to those skilled in the art that FIG. 1 omits for the sake of clarity a number of details of the construction of a projector, including the illuminating light source and the details of color separating and re-combining device 105 (125) which varies in its detailed configuration and components according to the type of SLM used.

The left hand projector 115 in FIG. 1 produces a projected image 102 on the screen 100, which proceeds from the lens 104 as more or less a cone of light as shown in FIG. 1 by the dashed lines connecting 104 to 102. Similarly, right hand projector 135 in FIG. 1 produces a projected image 122 on the screen 100, which also proceeds from lens 124 as more or less a cone of light as shown by the dashed lines connecting 124 to 122.

SLM based color projectors commonly employ a color separation and re-combining system using dichroic bandpass filters to separate white light into three spectral bands (corresponding to red, green and blue colors) prior to illuminating the SLMs and then recombine the modulated light from each of the three SLMs prior to the projection lens. The arrangement of the dichroic filters commonly uses a combination of each filter's selective reflection and transmission properties.

The exact wavebands associated with these properties are a function of the angle of the incident light. Color uniformity across the projected image therefore requires uniformity in the angles at which light reaches each of the dichroic filters in the color separation and re-combining system. This is achieved by an illumination relay with a telecentric input and output. The telecentric condition insures that all points on the dichroic filter see the same angular distribution of light from the source.

The system of FIG. 1 can provide adjustment of the color balance of the projectors in a multiple projection display by modifying the relative brightnesses of the red, green and blue image channels using the normal projector facilities for gain adjustment of the red, green and blue image channels. But this method has two important limitations. First, achieving a desired overall color balance for the composite display may require lowering the brightness of one or more of the red, green and blue brightnesses of both of the two projection displays, reducing the brightness of the composite display.

Second, adjusting color shift and color balance by manipulating the relative brightness of the three primary colors is only effective in the general case for displayed colors that contain some proportion of all three of the primaries. This means that saturated colors or colors that contain only two of the three primaries cannot in general be matched between displays by adjusting the brightness of the red, green and blue components of each display.

In order to appreciate the requirements and benefits of an improved means of adjusting the color of a projection display, a method is required that can quantify the visibility and range of color variations or differences found in projection displays and also permit evaluation of the effects of adjustments performed using the improved means of adjusting colors. This can be done using a psychophysically based system of color measurement and color difference evaluation.

A variety of techniques for evaluating the visibility of color differences are available in the literature known to those skilled in the art. These techniques are based on some form of three dimensional color space where equal increments of movement along each axis produce perceptually uniform changes in the color sensation experienced by most color normal viewers. A uniform color space allows the measurement of color differences and the comparison of the magnitudes of color differences. Using the techniques of color differences the color variations in a single display and the color variations expected between projectors can be analyzed and the effectiveness of methods for correcting those differences can be evaluated.

The International Commission On Illumination, abbreviated CIE after the French “Commission Internationale De L'eclairage”, is recognized by the International Organization for Standardization (ISO) as an international standardization body. Division 1 of the CIE has terms of reference which include the establishment of colorimetric systems. The CIE has standardized color matching functions that allow the numerical representation of color stimuli seen by a human observer in a consistent way that represents the color matching properties of the human visual system. Spectral energy distributions such as those that result when a light source is modulated by SLM devices and filtered by a color separating and re-combining device in a SLM based projector can be converted to numerical values using these color matching functions in appropriate calculations that are known to those skilled in the art.

The resulting numerical values or chromaticities can be plotted on various diagrams that are also standardized by the CIE. One of these is the xy diagram, which plots the chromaticity values in terms of a coordinate pair that represents the chromatic component of the stimulus independent of its luminance.

On the CIE xy diagram straight lines connect the additive mixtures of stimuli represented by points on the diagram. These mixtures follow a “center of gravity” rule where the location of the resulting color stimulus is located by dividing the line in proportion to the amounts of the stimuli. For example, an equal mixture of two color stimuli results in a new color stimulus located at the midpoint of the line connecting the two initial stimuli.

The CIE has also established methods for predicting the magnitude of perceived color differences. The CE L*u*v* uniform color system (abbreviated LUV) is an approximately uniform color space that can be used to graphically depict the relationship of different colors. LUV is a linear transformation of CIE tristimulus values. In the examples provided herein, the color matching functions for the CIE 1931 2° observer have been used to compute tristimulus values. LUV chromaticities can be plotted in two dimensions at a selected value of L* in terms of u* and v* which in this form represents a projective transformation of the CIE xy diagram. CIE tristimulus values are converted to LUV values using equations well known in the art. The LUV values also take into account the chromatic adaptation of the observer by incorporating the chromaticity of a selected white point which always plots at the 0,0 point on a u*v* diagram.

The u*v* diagrams also have the property that straight lines connect the additive mixtures of stimuli represented by points on the diagram. Because an additive color mixing system is being analyzed this permits straightforward computer modeling of the color correction methods used by the present invention. Although the most current work shows that LUV contains some important defects when used to predict color appearance attributes, the u*v* diagram predicts color differences related to correlated color temperatures near the Planckian loci of the CIE xy diagram better than the alternative uniform color spaces. Also the u*v* diagram is the most straightforward to use with additive color systems because of its linear treatment of additive color mixing as previously described. Although the use of a more sophisticated color appearance model might change the magnitudes and character of the color differences measured for projection display systems, the principles of this invention for the further adjusting of color would remain unaffected and other color appearance models could be used by those skilled in the art.

The color adjustment requirements for matching projection displays can be understood by considering the source of color variations between displays. There are four major sources of color variation in a well designed SLM based projection display. These are the lamp and reflector; the transmission spectra of the various filters and mirrors used in the optical system; field dependent color shifts due to variations in the angle of incidence of the light that reaches the color filters in the color separating and recombining device; and the color of the glass and coatings used in the lens system. The purpose of the present invention is to address the effects of variations in the first three groups, that is, color variations due to the characteristics of the concentrating reflector used with the illuminating lamp, field dependent color shifts due to variations in the angle of incidence of the light that reaches the color filters in the color separating and re-combining device and changes in the transmission spectra of filter components.

As previously discussed, the filters commonly used in the color separating and re-combining device used in SLM based color projectors are dichroic filters. These filters have a spectral reflectance and transmittance that is a function of the incident angle of the light passing through the filter. In typical color separation and re-combining systems the angle of incidence used is other than 0 degrees. The wavelength shift for a dichroic filter is approximated by the following equation (1):

$${λ}_{s} = \frac{λ}{n} * \sqrt{{n}^{2} - {sin}^{2} θ} \qquad ( 1 )$$

where:
λₛ=wavelength resulting from tilt angle θ
λ=the wavelength at zero angle of incidence
n=the effective refractive index of the dichroic coating stack

As the equation shows a filter used at non-zero angles of incidence when tilted to greater angles will shift its transmission spectrum towards the shorter wavelengths and when titled to lesser angles will shift its transmission spectrum towards the longer wavelengths.

In the following description, a pair of projectors is considered, arranged as shown in FIG. 1. One projector is considered to be the reference, and its white point for nominal lamp spectral emission and the design center for the filter components is used as the illuminant white point for the calculation of u*v* coordinates and the subsequent calculation of delta E color difference values according to the formula (2):
ΔE=\sqrt{ΔL*²+Δu*²+Δv*²} (2)
where:
ΔE=delta E color difference
ΔL*=L*_{reference}−L*_{shifted}|
Δu*=|u*_{reference}−u*_{shifted}|
Δv*=|v*_{reference}−v*_{shifted}|

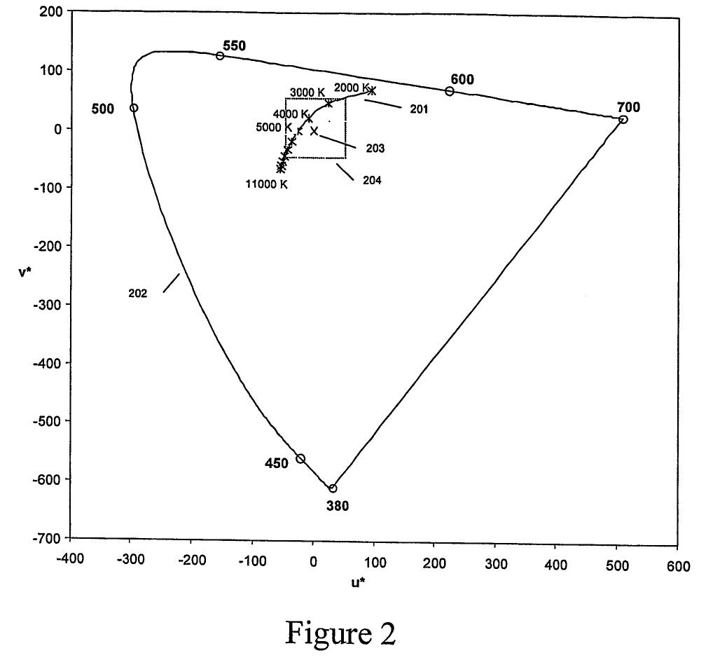

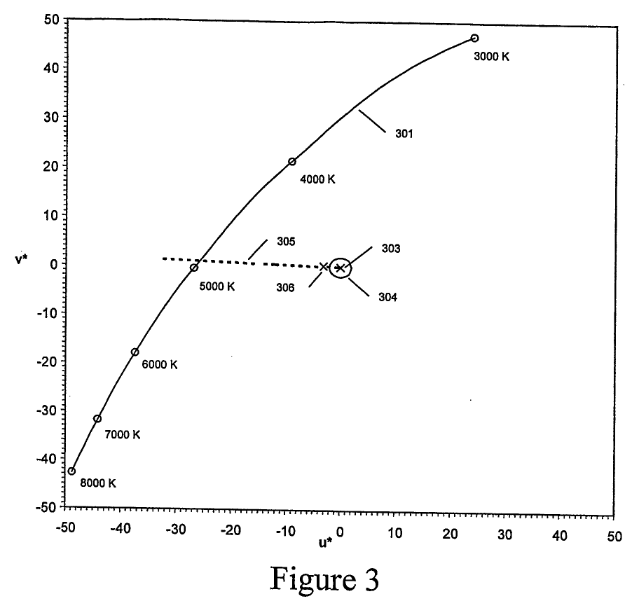

FIG. 2 is a u*v* diagram in the plane where L*=100, showing the u*,v* coordinates of the Planckian spectral loci 201, the u*,v* coordinates of the pure spectral colors 202, and the color coordinates of the white point 203 for a typical SLM based projector using DMD devices. FIG. 3 is a plot of the region shown in dashed outline at 204 in FIG. 2. Again, 301 are the Planckian loci and 303 is the white point for typical three SLM based projector using DMD devices. The circle 304 shows the radius of two delta E units of color difference from the white point 303. The line 305 shows the direction of color shift for the projector white point caused by a variation in the tilt angle of the illuminating light to a greater angle than intended on the red, green and blue dichroic filters used in the color separating and re-combining device of the projector.

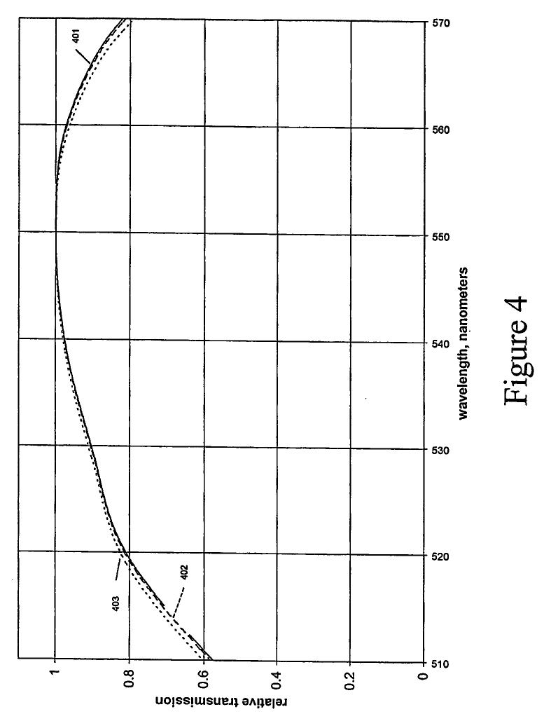

FIG. 4 shows the effect of increasing the angle of incidence for the illumination of the green filter in the color separating and re-combining device of the projector by 3 degrees and 6 degrees. The curve 401 is the transmission at the correct angle of incidence, and curves 402 and 403 respectively correspond to 3 and 6 degree increases in the angle of incidence. The magnitude of the shift for the dominant wavelength of the filter is approximately 2.5 nanometers of wavelength for the angle of incidence increase of 6 degrees. A shift of this amount for all three colors corresponds on the diagram of FIG. 3 to the first X 306 outside of the two delta E circle 304 on the line 305. The delta E values for each of the three primaries and the white point for a shift of 2.5 nanometers are as follows:

Delta E

| R | G | B | White Point |
|---|---|---|---|
| 7.186151 | 3.327496 | 3.76714 | 3.13456 |

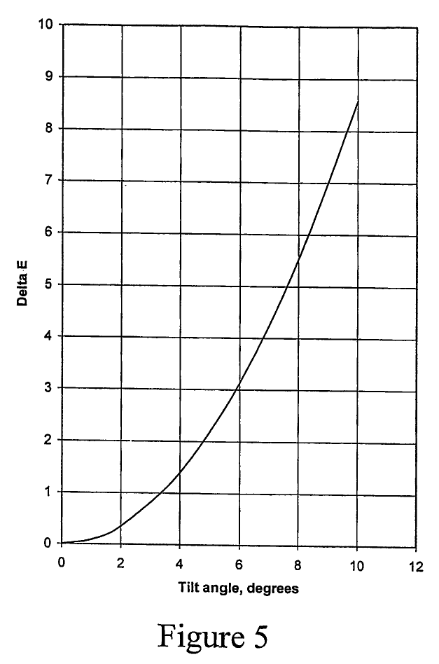

FIG. 5 shows the delta E value for the white point of the display as a function of increasing angle of incidence for the three dichroic filters. It should be understood that the angle of incidence changes used in these examples serve as a proxy for more complex variations. In general, it is possible that, depending on the design of the color separating and re-combining device in the projector, a more complex variation in angle of incidence for the dichroic filters may arise. In some cases, it may be possible to fully optimize the angle of incidence for at least one of the filters. The variation of the angle of incidence also serves as a proxy for other sources of shift in the filter's transmission spectra such as those caused by variations in the coating thickness for various layers of the complex multi-layer stacks generally used in such filters. In the manufacturing of dichroic filters used in SLM based projectors for color separation and re-combining a dominant wavelength and overall passband tolerance of ±5 nm is considered a very tight tolerance, near the limits of repeatability.

The delta E methods used in these examples are best suited to evaluate color differences for adjacent areas of color, such as those found on either side of the seam region of a tiled display. The magnitude of delta E that corresponds to a visible difference is not an absolute. Color differences are significantly affected by viewing conditions. A delta E of two corresponds reasonably well to the smallest visible color difference between white points on two projection displays in a tiled configuration at screen luminance levels of 12 to 16 foot lamberts. The bit depth of the display limits the ability of a display that might be used to show a color simulation of color differences. On the 8 bit per color displays typical of most computers a simulated color difference of three is just visible under ideal viewing conditions. However, a projection display suited to high quality applications uses either a 10 bit per color logarithmic data format or a 14 to 16 bit linear format in order to provide the dynamic range and fidelity required.

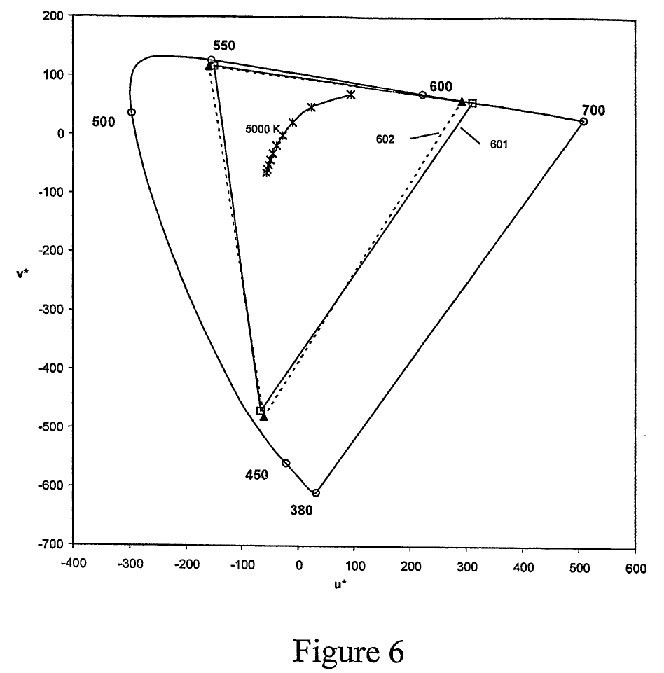

The other effect of color shifts in the color separating and re-combining device of the projector is to alter the gamut of displayable colors. FIG. 6 compares the gamut of a reference projector 601 to the gamut of a projector 602 where the passbands of the three color separation and re-combining filters are shifted by 5 nanometers.

The present invention allows the adjustment of color in an SLM based projection system by controlling the spectral energy distribution of the light entering the color separating and re-combining device. This can correct for variations in the color of the input light caused by variations in the lamp and reflector system and also correct for variations in the colors produced by the color filters in the color separating and re-combining device. The present invention exploits the realization that for an additive color mixing system comparatively broad band color filters are used in the color separating and re-combining device, which in turn produce broad band color stimuli that are perceived by the human observer whose visual system also has broad band responses to color. By adding narrowband light energy within the passband of each of the broad band color filters in the color separating and re-combining device into the illuminating light input to the color separating and re-combining device the perceived color can be altered. If both the optical power and the wavelength range of the narrowband source are adjustable then color variations in the system can be controlled and the primary colors of the resulting display matched to the desired standard colors.

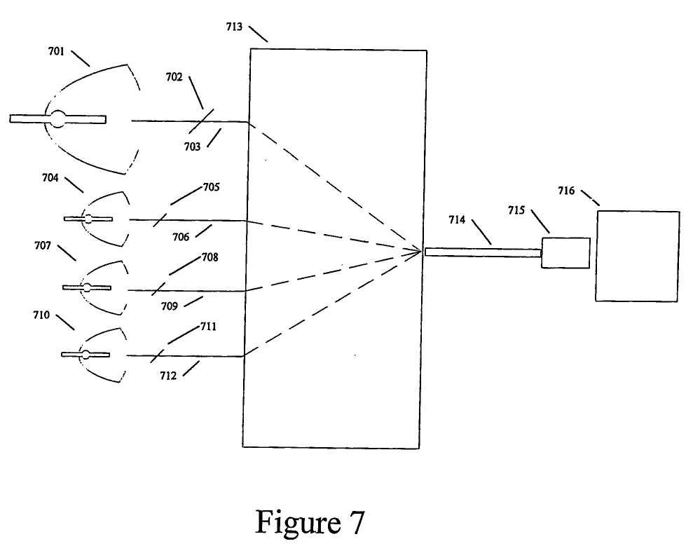

A first exemplary embodiment of this invention is shown in schematic diagram form in FIG. 7, which forms the illumination system of a projector incorporating the methods of the present invention. At 701 the main illumination source consists of a reflector assembly and a high pressure Xenon arc lamp. An elliptical reflector and a spherical retro-reflector combination is shown, but other reflector and lamp combinations may be used and are known to those skilled in the art. The unwanted infrared component of the light from 701 is removed by selectively reflecting filter 702. Light 703 from filter 702 is then directed to illumination integrating bar 714 by light mixing system 713. The output of integrating bar 714 is then focused into the desired illumination cone by relay 715 and then directed into color separating and re-combining device 716 where it illuminates the SLM devices. The color separating and re-combining device 716 is analogous to the color separating and re-combining device 105 shown in FIG. 1, and the balance of the projection optical system including the SLMs, electronics and projection lens may be inferred by reference to FIG. 1.

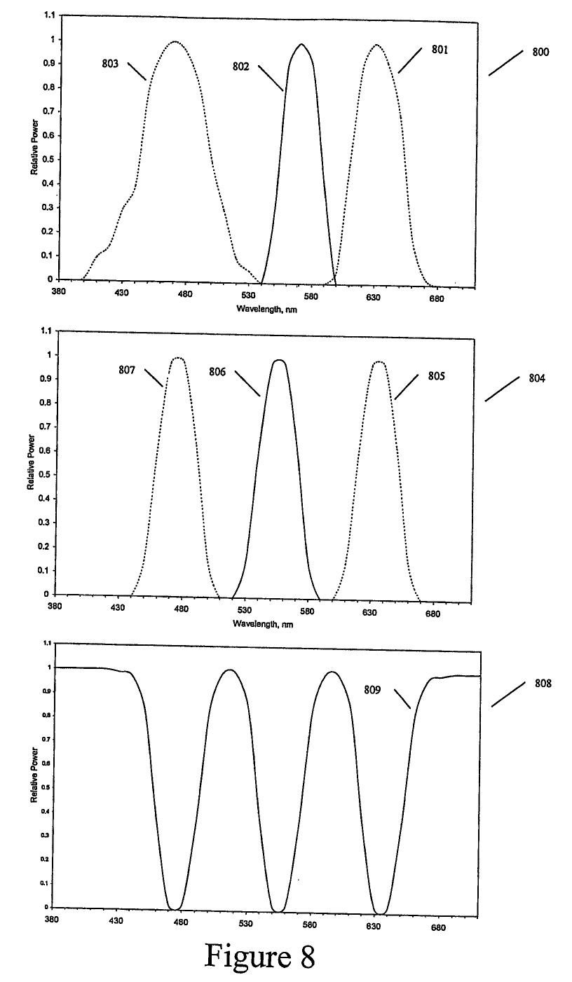

In a typical projector the main illumination source may be a Xenon arc lamp with an input power rating of 3 kW or more. This source provides the main source of illumination for the projected image. Secondary illumination sources are provided for color correction. These sources consist of lamp and reflector assemblies 704, 707 and 710 in conjunction with wavelength selecting filters 705, 708 and 711. Lamp and reflector assembly 704 and wavelength selecting filter 705 produce an illuminating light 706 with an optical power of approximately 20% of that of the main source with a wavelength distribution confined to the red portion of the spectrum, for example curve 801 on graph 800 in FIG. 8. Light 706 is then mixed with the light from the main source 701 and directed to illumination integrating bar 714 by light mixing system 713.

Similarly, lamp and reflector 707 and wavelength selecting filter 708 produce an illuminating light 709 with an optical power of approximately 20% of that of the main source with a wavelength distribution confined to the green portion of the spectrum, for example curve 802 on graph 800 in FIG. 8. The illuminating light 709 is then mixed with the light from the main source 701 and the light from secondary source 704 and directed to illumination integrating bar 714 by light mixing system 713.

Similarly lamp and reflector 710 and wavelength selecting filter 711 produce an illuminating light 712 with an optical power of approximately 20% of that of the main source with a wavelength distribution confined to the blue portion of the spectrum, for example curve 803 on graph 800 in FIG. 8. The illuminating light 712 is then mixed with the light from the main source 701 and the light from secondary sources 704 and 707 and then directed to illumination integrating bar 714 by light mixing system 713.

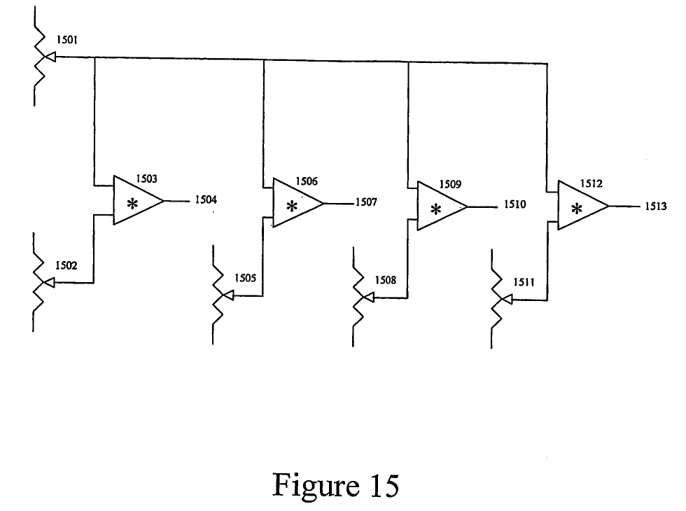

As a result, the total illumination received by integrating bar 714 is the sum of the light from each of the four lamp and reflector systems and associated filters. Each of the secondary illumination sources is provided with a controlling device so that the contribution of each source to the total illuminating light entering 714 may be adjusted. This can be accomplished, for example, by controlling the power supplied to each of the secondary illumination lamps in the lamp and reflector combinations 704, 707 and 710 or by controlling the amount of light 706, 709 and 712 that reaches the integrating bar by means of a variable optical attenuator such as an adjustable aperture or a variable neutral density filter. Secondary power control signals are calculated, for example, as described below with reference to FIG. 15.

The light mixing system 713 in FIG. 7 can be constructed in various ways. A simple example is a mirror arrangement, such as a four sided pyramid that shares the input aperture of the integrator rod 714 between the four sources. There are efficiency considerations in such a sharing arrangement. The area of the SLM devices on the color separating and re-combining device 716 and the f-number of the projection lens normally determine the limiting étendue in the illumination system of the projector. The integrator rod input aperture is usually matched to this étendue, taking into consideration any magnification that may be provided by the relay optics 715. The étendue of the illuminating source is generally much larger and as a consequence only a portion of the total flux from the illumination source is coupled into the projector's illumination system.

A system like that in FIG. 7 must share the SLM étendue between the main and secondary sources and this sharing will have an impact on the efficiency of the system. The biggest impact will be on the efficiency of the main source since it will have the largest arc and therefore it will have the greatest mismatch to the étendue of the SLM.

For wider aspect ratios used in some displays, such as those required for motion picture applications, the input aperture of the integrator rod may be under filled in one direction by the main source 701. It is then possible to arrange the mixing system 713 to fill in the edges of the input aperture with the light from the secondary sources 704, 707 and 710.

As is shown below, it is possible that for some applications it will not be necessary to provide 3 secondary sources, and in those cases the problem of sharing the SLM étendue is reduced. Other alternative configurations for the light mixing system 713 will be known to those skilled in the art, and these may be employed without departing from the spirit of the invention.

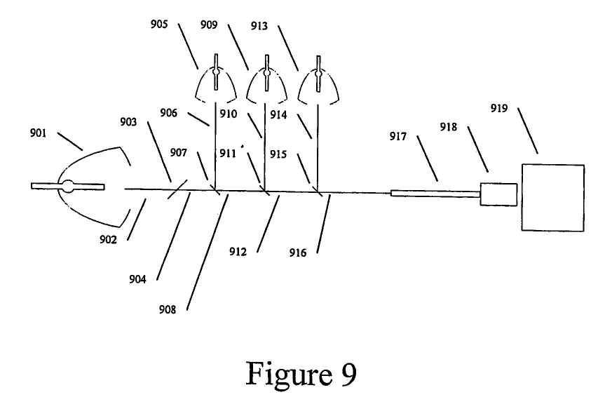

A second exemplary embodiment is shown in FIG. 9 that arranges the main and secondary illumination sources so that the SLM étendue does not have to be shared between the sources. Main illumination source 901 again consists of a reflector assembly and a high pressure Xenon arc lamp. An elliptical reflector and a spherical retro-reflector combination is shown, but other reflector and lamp combinations may be used and are known to those skilled in the art. The unwanted infrared component of the light 902 from 901 is removed by selectively reflecting filter 903. Light 904 from filter 903 then proceeds to illumination integrating bar 917. The output of integrating bar 917 is then focused into the desired illumination cone by relay 918 and then directed into color separating and re-combining device 919 where it illuminates the SLM devices. The color separating and re-combining device 919 is analogous to the color separating and re-combining device 105 shown in FIG. 1, and the balance of the projection optical system including the SLMs, electronics and projection lens may be inferred by reference to FIG. 1.

Lamp and reflector assembly 905 produces secondary illumination light 906, which is folded through 90 degrees by wavelength selective reflector 907. The portion of the light 906 that is reflected by 907 becomes illuminating light 908 which has an optical power of approximately 20% of that of the main illumination source with a wavelength distribution confined to a narrow portion of the red region of the spectrum, for example curve 805 on graph 804 in FIG. 8. Wavelength selective reflector 907 reflects the desired portion of the light from secondary illumination source 905 and transmits all of the light 904 from the main illumination source 901 outside of the portion of the spectrum that corresponds to the reflected light 908. The input aperture of illumination integrating bar 917 is now fully available to sources 901 and 905, with the loss of light 904 from the main source 901 confined to the narrow portion of the spectrum that corresponds to the reflected light 908.

Lamp and reflector assembly 909 produces secondary illumination light 910, which is folded through 90 degrees by wavelength selective reflector 911. The portion of the light 910 that is reflected by 911 becomes illuminating light 912 which has an optical power of approximately 20% of that of the main source with a wavelength distribution confined to a narrow portion of the green region of the spectrum, for example curve 806 on graph 804 in FIG. 8. Wavelength selective reflector 911 reflects the desired portion of the light from secondary source 909 and transmits all of the light 904 from the main source 901 outside of the portion of the spectrum that corresponds to the reflected light 912. Wavelength selective reflector 911 also transmits all of the light 908 from secondary source 905. The input aperture of illumination integrating bar 917 is now fully available to sources 901, 905 and 909, with the loss of light 904 from the main source 901 confined to the narrow portions of the spectrum that correspond to the reflected light 908 and reflected light 912.

Lamp and reflector assembly 913 produces secondary illumination light 914, which is folded through 90 degrees by wavelength selective reflector 915. The portion of the light 914 that is reflected by 915 becomes illuminating light 916 which has an optical power of approximately 20% of that of the main illumination source with a wavelength distribution confined to a narrow portion of the blue region of the spectrum, for example curve 807 on graph 804 in FIG. 8. Wavelength selective reflector 915 reflects the desired portion of the light from secondary source 913 and transmits all of the light 904 from the main illumination source 901 outside of the portion of the spectrum that corresponds to the reflected light 916. Wavelength selective reflector 915 also transmits all of the light 908 from secondary illumination source 905 and all of the light 912 from secondary illumination source 909. The input aperture of illumination integrating bar 917 is now fully available to sources 901, 905, 909 and 913 with the loss of light 904 from the main illumination source 901 confined to the narrow portions of the spectrum that correspond to the reflected light 908, reflected light 912 and reflected light 916. The resulting spectrum for the transmission of light 901 through filters 907, 911 and 915 is approximated by curve 809 on graph 808 in FIG. 8. Each of the secondary illumination sources is provided with a controlling device so that the contribution of each source to the total illuminating light entering 917 may be adjusted. This can be accomplished, for example, by controlling the power supplied to each of the secondary illumination lamps in the lamp and reflector combinations 905, 909 and 913 or by controlling the amount of light 908, 912 and 916 that reaches the integrating bar by means of a variable optical attenuator such as an adjustable aperture or a variable neutral density filter. Secondary power control signals are calculated, for example, as described below with reference to FIG. 15.

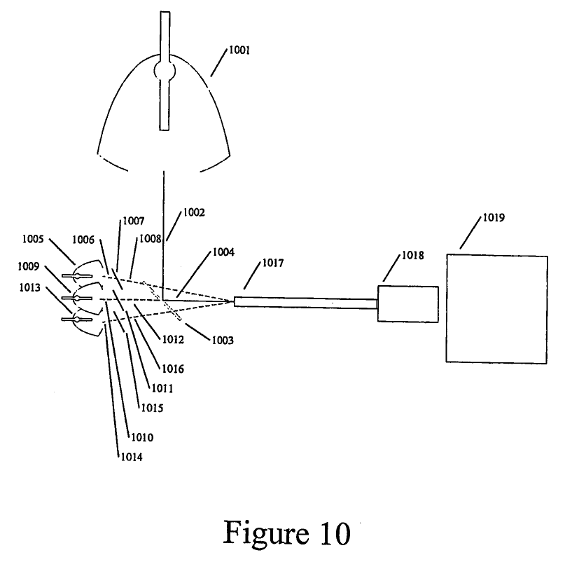

A third exemplary embodiment is shown in FIG. 10 that also arranges the main and secondary illumination sources so that the SLM étendue does not have to be shared between the sources. Main illumination source 1001 again consists of a reflector assembly and a high pressure Xenon arc lamp. An elliptical reflector and a spherical retro-reflector combination is shown, but other reflector and lamp combinations may be used and are known to those skilled in the art. Selectively reflecting mirror 1003 transmits the unwanted infrared component of the light 1002 while reflecting the desired illuminating light 1004 through 90 degrees. Illuminating light then proceeds to illumination integrating bar 1017. The output of integrating bar 1017 is then focused into the desired illumination cone by relay 1018 and then directed into color separating and re-combining device 1019 where it illuminates the SLM devices. The color separating and re-combining device 1019 is analogous to the color separating and re-combining device 105 shown in FIG. 1, and the balance of the projection optical system including the SLMs, electronics and projection lens may be inferred by reference to FIG. 1.

Lamp and reflector assembly 1005 produces secondary illumination light 1006, which passes through wavelength selective reflector 1007. Wavelength selective reflector 1007 reflects the unwanted portion of the light from secondary illumination source 1005 and transmits the desired portion which becomes illuminating light 1008 which has an optical power of approximately 20% of that of the main illumination source with a wavelength distribution confined to a narrow portion of the red region of the spectrum, for example curve 805 on graph 804 in FIG. 8. Selectively reflecting mirror 1003 transmits the light 1008, and reflects all of the light 1004 from the main source 1001 outside of the portion of the spectrum that corresponds to the transmitted light 1008. The input aperture of illumination integrating bar 1017 is now fully available to main source 1001, with the loss of light 1004 from the main illumination source 1001 confined to the narrow portion of the spectrum that corresponds to the transmitted light 1008.

Additional secondary illumination sources may be added as shown in FIG. 10, where lamp and reflector assembly 1009 produces secondary illumination light 1010 and in combination with wavelength selective reflector 1011 produces illuminating light 1012 which has an optical power of approximately 20% of that of the main source with a wavelength distribution confined to a narrow portion of the green region of the spectrum, for example curve 806 on graph 804 in FIG. 8. Similarly lamp and reflector assembly 1013 produces secondary illumination light 1014 and in combination with wavelength selective reflector 1015 produces illuminating light 1016 which has an optical power of approximately 20% of that of the main illumination source with a wavelength distribution confined to a narrow portion of the blue region of the spectrum, for example curve 807 on graph 804 in FIG. 8. Since each of the secondary sources 1005, 1009 and 1013 will have smaller lamps, and therefore smaller arcs with a correspondingly smaller étendue, the available étendue of the SLM devices as represented by the input aperture of integrator 1017 may be shared by suitable shaping of the intensity distribution from each of the secondary illumination sources. These sources may be arranged for example at the vertices of a triangle (represented in the plan view of FIG. 10 by the partial overlapping of the representations of the three secondary sources) and a portion of the total acceptance angle of the integrator rod allocated to each of the sources. Each of the secondary illumination sources is provided with a controlling device so that the contribution of each source to the total illuminating light entering 1017 may be adjusted. This can be accomplished, for example, by controlling the power supplied to each of the secondary illumination lamps in the lamp and reflector combinations 1005, 1009 and 1013 or by controlling the amount of light 1008, 1012 and 1016 that reaches the integrating bar by means of a variable optical attenuator such as an adjustable aperture or a variable neutral density filter. Secondary power control signals are calculated, for example, as described below with reference to FIG. 15.

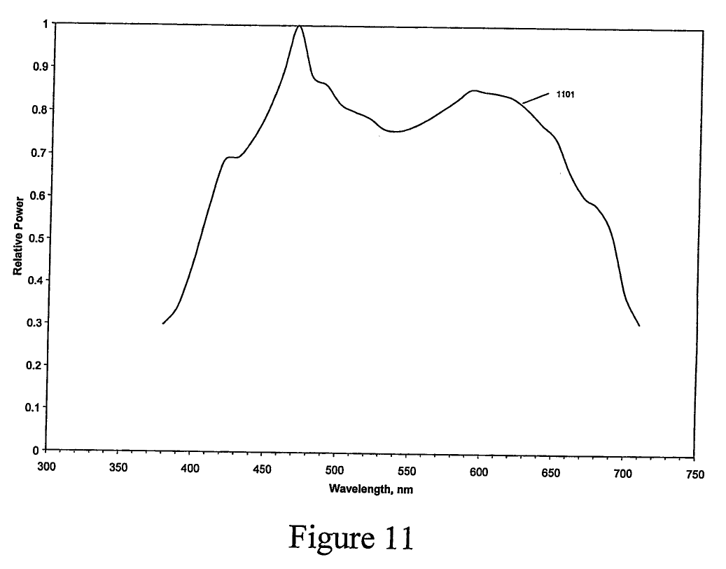

The designs of FIGS. 9 and 10 may be optimized by considering for example the spectral energy distribution of main illuminating source 901, which for a Xenon lamp is similar to that shown at 1101 in FIG. 11. As the figure shows, some portions of the curve contain less of the total power, and if the secondary illumination source wavelengths are placed in these regions the loss of power from the main source will be reduced.

It is also important to note that in the systems of FIGS. 7, 9 and 10 the spectral energy distribution of each of the secondary illumination sources will be filtered by the color filters in the color separating and re-combining device of the projector. This affects the choice of spectra for the secondary illumination sources, and it is important with respect to efficiency that these sources be located in a spectral region where the passband of the corresponding color separating and re-combining device filter has reasonably high transmission.

The use of broad band widths for the filters of the color separating and re-combining device is desirable for efficient use of the light from a white light source such as a Xenon lamp. The broad band widths also reduce the tendency for light to scatter in the color separation and re-combining system, and reduce the effect of shifts of passband wavelength since the eye averages the total light through each filter. Narrow band sources have the disadvantage of being less efficient and more sensitive to wavelength shifts since the color shift due to a change in their wavelengths is more easily seen.

However, if the angle of incidence on the wavelength selecting reflectors 907, 911 and 915 (or 1007, 1011 and 1015) is made adjustable, variation in color from the secondary illumination sources can be eliminated. As would be known to one skilled in the art, some means must also be provided for compensating the change in the direction of reflection so that the light remains focused on the input of integrating bar 917 (or 1017).

Another embodiment of the apparatus of FIGS. 9 and 10 can be realized by eliminating the main illumination source 901 or 1001 entirely, and increasing the power of illumination sources 905 (1005), 909 (1009) and 913 (1013). In some applications this may prove to be a more efficient arrangement, particularly since the photopic weighting of powers for the three sources results in the green source having a higher total flux requirement than the red and blue sources, which improves the overall efficiency of such an arrangement by requiring less power from the red and blue secondary sources.

It is also desirable that the intensity distributions of the main and secondary illumination sources be matched so that unwanted non-uniformities in color do not arise in applications where the subsequent optical system may modify the intensity distribution of the combined sources.

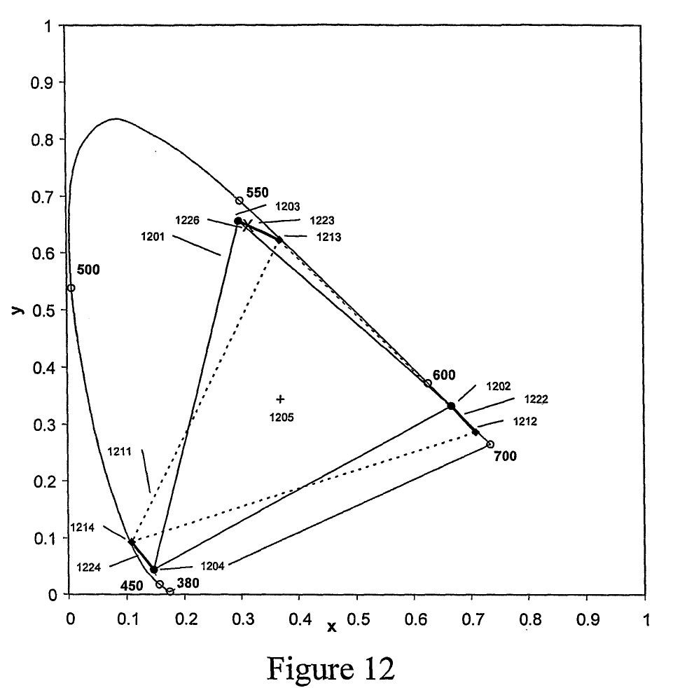

The operation of the apparatus of FIG. 7 may be understood with reference to FIG. 12. This discussion also applies to the systems of FIGS. 9 and 10 and their corresponding components. FIG. 12 shows a CIE xy diagram using the color matching functions for the 1931 2 degree observer. The solid line forming triangle 1201 connects three points 1202, 1203 and 1204 which are the x and y chromaticity values for the red, green and blue color filters of the color separating and re-combining device 716 in FIG. 7. This triangle represents the gamut of colors that can be formed by all combinations of brightnesses of the three color channels of a projection system that employs the color separating and re-combining device 716 of FIG. 7 if it were illuminated by the main illumination source without the contribution of the secondary illumination sources (all secondary illumination optical powers are set to zero).

Similarly, the dashed line forming triangle 1211 connects the three points 1212, 1213 and 1214 which are the x and y chromaticity values for red, green and blue secondary illumination sources and filters 704 and 705, 707 and 708, and 710 and 711 in FIG. 7. Triangle 1211 represents the gamut of colors that would be formed by all combinations of various optical powers of the three secondary sources 704, 707 and 710 as filtered by the filters 705, 708 and 711 in FIG. 7 and subsequently by the color filters of the color separating and re-combining device 716 of FIG. 7 without the contribution of the main illumination source.

The three color channels of the projector control the SLM devices to modulate the light that is directed to the screen by the color separating and re-combining device and the projection lens. The light entering the color separating and re-combining device is the sum of the main illumination source and the secondary illumination sources as previously described. The color that is displayed when the brightness of all three channels of the projector are driven to their maximum value, or 100% of full scale, is by convention called the white point of the display. The white point for the gamut of the projector with the optical power of the secondary sources set to zero is shown at 1205. The chromaticity of the white point of any three primary color gamut is computed as follows in formula (3):

$$WPx = \frac{Rx + Gx + Bx}{3} \\ WPy = \frac{Ry + Gy + By}{3} \qquad ( 3 )$$

where
   Rx, Ry=chromaticities of the red primary
   Gx, Gy=chromaticities of the green primary
   Bx, By=chromaticities of the blue primary
   WPx, Wpy=chromaticities of the white point where R=G=B=100%

In other words, the white point of the display is the centroid of the triangle formed by the three primaries. Primary means a set of three spectral energy distributions that are selected such that none of the three spectral energy distributions can be matched by a mixture of the other two. In terms of the chromaticity diagram this results in a triangle, since by definition a triangle is formed by three non-collinear points. The selection of primaries for an image projection system is not arbitrary. In general the primaries are selected so that the gamut formed by the three primaries includes all of the colors that the system is required to reproduce.

As previously discussed the color of this white point can be adjusted by changing the gain of one or more of the color channels in the projector so that an input pixel brightness value of 100% for each of red, green and blue is displayed with pixel brightness values of less than 100% for one or more of the three colors according to the desired white point. However, as also discussed this reduces the maximum brightness of the display and also in general can only correct the color balance for neutral tones and other colors that are mixtures of all three of the primaries.

The addition of a second set of primaries to the system allows the color balance of the display to be altered without reducing the pixel brightness for any of the three colors, and permits adjustment of the primary chromaticities of the display resulting in an actual shifting of the white point and the associated gamut. This can be understood with reference to FIG. 12 as follows.

The vector 1223 connecting the points 1203 and 1213 is the line along which all combinations of mixture for the green primary and the green secondary source will be found. The ratio of the optical powers of these two sources is equal to a proportion of the distance along the vector 1223. The mixture that is formed when each source is at the same optical power is located at the midpoint of the vector 1223. In the example system of FIG. 7 the maximum optical power of the secondary sources was selected to be approximately 20% of the optical power of the main source. This limits the distance along the vector 1223 that the mixture can travel from the primary 1203 to the secondary 1213 to that shown by the “X” at 1226 in FIG. 12.

Similarly the vector 1222 connecting the points 1202 and 1212 is the line along which all combinations of mixture for the red primary and the red secondary source will be found. The ratio of the optical powers of these two sources is equal to a proportion of the distance along the vector 1222. The mixture that is formed when the two sources are at the same optical power is located at the midpoint of the vector 1222. In the example system of FIG. 7 the maximum optical power of the secondary illumination sources was selected to be approximately 20% of the optical power of the main illumination source. This limits the distance along the vector 1222 that the mixture can travel from the primary 1202 to the secondary 1212.

The vector 1224 connecting the points 1204 and 1214 is the line along which all combinations of mixture for the blue primary and the blue secondary source will be found. The ratio of the optical powers of these two sources is equal to a proportion of the distance along the vector 1224. The mixture that is formed when the two sources are at the same optical power is located at the midpoint of the vector 1224. In the example system of FIG. 7 the maximum optical power of the secondary sources was selected to be approximately 20% of the optical power of the main illumination source. This limits the distance along the vector 1224 that the mixture can travel from the primary 1204 to the secondary 1214.

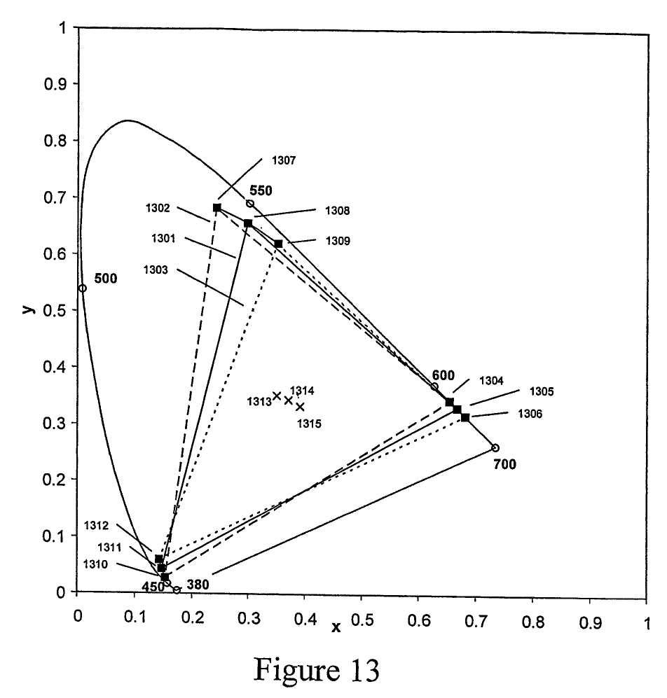

FIG. 13 is a CIE xy diagram which shows the effect of varying the angle of incidence on the chromaticities of each of the primary color filters in the color separating and re-combining device 716 in FIG. 7. The triangle at 1301 shown with a solid line connects the loci of the three primary chromaticities 1305, red, 1308, green, and 1311, blue for the three primary filters at the nominal angle of incidence and represents the gamut of colors that can be displayed with these primaries. The resulting white point for these three primary chromaticities is shown at 1314. The triangle 1302, shown with a dashed outline connects the loci of the three primary chromaticities 1304, red, 1307, green, and 1310, blue for the three primary filters at an angle of incidence greater than the nominal angle of incidence and represents the gamut of colors that can be displayed with these primaries. The resulting white point for these three primary chromaticities is shown at 1313. The triangle 1303, shown with a dotted outline connects the loci of the three primary chromaticities 1306, red, 1309, green, and 1312, blue for the three primary filters at an angle of incidence less than the nominal angle of incidence and represents the gamut of colors that can be displayed with these primaries. The resulting white point for these three primary chromaticities is shown at 1315.

The diagram in FIG. 13 shows the expected effect of varying the angle of incidence or shifting the spectral passband of each filter. The effect is to move the chromaticity of the primaries more or less along the spectral loci, towards the longer wavelengths for a decrease in the angle of incidence, and towards the shorter wavelengths for an increase in the angle of incidence. Formula (1) given earlier also predicts that the wavelength shift with a change of angle of incidence will be greater for longer wavelengths, but FIG. 13 appears to suggest that the shift is greatest for the green primary.

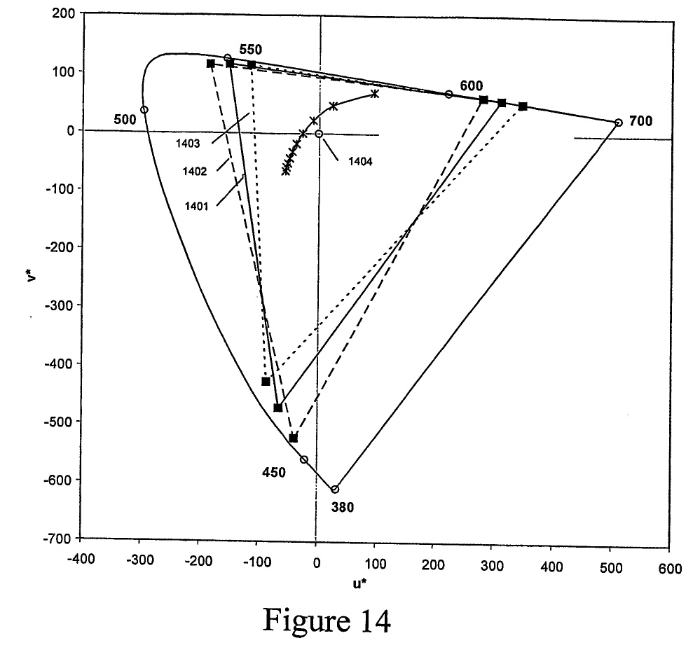

FIG. 14 shows the same information as FIG. 13, but plotted on a u*v* diagram, centered on the white point 1404 of the three primaries with the nominal angle of incidence. The triangle 1401 and its vertices represent the chromaticities of the primaries at the nominal angle of incidence, and the triangle 1402 represents the effect of an increased angle of incidence while the triangle 1403 represents the effect of a decreased angle of incidence. Here the distance traversed by each primary is more nearly equal because of the more uniform character of the u*v* diagram.

Because longer wavelengths are shifted more for a given change of angle of incidence there is also a change in the width of the passband for a dichroic filter. As the angle of incidence increases the longer wavelength side of the passband moves further towards the shorter wavelengths than does the short wavelength side of the passband. This results in a slight narrowing of the passband as the angle of incidence increases. This accounts for a non-linear movement of the chromaticities which is most easily seen for the blue primary in FIG. 14.

It should now be clear that a preferred method of determining the optical power settings for the secondary sources is to first determine the chromaticities of the primary sources alone, and then to add the required amount of each secondary source to the primary source so as to bring the resultant mixture as close as possible to the desired chromaticity for each primary. When this is done the resulting white point will also be located at the desired chromaticity.

The chromaticity coordinates for a mixture of two colors can be calculated as follows in formula (4):

$${M}_{x} = C {1}_{x} - [ ( C {1}_{x} - C {2}_{x} ) * \frac{α C 2}{α C 1 + α C 2} ] \\ {M}_{y} = C {1}_{y} - [ ( C {1}_{y} - C {2}_{y} ) * \frac{α C 2}{α C 1 + α C 2} ] \qquad ( 4 )$$

Where
Mx,My=x,y chromaticity coordinates of the mixture of color C1 and C2
C1ₓ,C1_{y}=x,y chromaticity coordinates of the color C1
C2ₓ,C2_{y}=x,y chromaticity coordinates of the color C2
αC1=amount of color 1
αC2=amount of color 2

The color amounts are in arbitrary units, typically a range of 0 to 1 is used. For example, the chromaticity for the green primary source 903 in FIG. 9 may be represented by C1, and the chromaticity for the green secondary source 913 in FIG. 9 may be represented by C2. The amount of C1 is then 1, and the amount of C2 (using the instance of a secondary source with 20% of the power of C1) is 0.2.

A preferred embodiment of the inventions in FIGS. 7, 9 and 10 would use secondary sources with chromaticities that are located along the vector representing the anticipated color shift of the primaries in the color separating and re-combining device, and located in the direction opposite that of the expected shift. Optimization of such a design would require selection of tolerances and specifications for these filters that would produce an appropriate bias in the chromaticity range of the color separation and re-combining primaries, and also allow for tolerances in the color filters of the secondary sources.

It is possible that a given system may not require the adjustment of all three primary chromaticities. While three sources provides the most general configuration, if the nature of the color shifts exhibited by a particular display system are carefully evaluated in a particular application only one or two secondary sources may be required. It should also be clear that if the requirement is to match the white point, without fully correcting the colors of the primaries, then a single optimally positioned secondary source would allow adjustment of the white point along the vector connecting that secondary source with the uncorrected white point of the display.

Referring again to FIG. 13, in general the selection of chromaticities for the secondary sources is made in such a way as to ensure that the gamut of the system can be adjusted in the required directions and over the required range while keeping the power of the secondary sources as low as practical, particularly when two or more secondary sources are required. A system providing the most general operation will preferably have equal lengths for all three of the vectors connecting the main and secondary sources, providing the greatest possibilities for shifting the primary chromaticities in any direction.

It is also preferable that the systems of FIGS. 7, 9 and 10 incorporate a facility for adjusting the overall brightness of the display in an achromatic fashion. That is, the facilities provided for brightness adjustment should act to maintain the ratio of flux levels between the main illumination source and the secondary illumination sources as the display brightness is adjusted. This adjustment system may be described by reference to the block diagram of FIG. 15.

The overall brightness of the display is controlled by master brightness control 1501. This may be, for example, a software selected value, adjusted as a percentage of full scale from 0 to 100 percent. Similarly 1502 is the main source optical power control, also software selected value ranging from 0 to 100 percent. The function at 1503 is a multiplier which causes the main source optical power command 1504 to be formed as the product of the master brightness control value 1501 and the main source optical power control value 1502. The main source optical power command 1504 may be for example a binary number corresponding to the selected optical power that is in turn supplied to a digital to analog converter and the resulting voltage used to control the main source lamp power via an adjustable output lamp power supply.

Control 1505 is the optical power control for the red secondary source. This may be a software selected value, adjusted as a percentage of full scale from 0 to 100 percent, that is set to the value determined by the calculations previously described to adjust the chromaticity of the red channel of the display system. This value is processed by multiplier function 1506 which forms the red secondary source optical power command 1507 as the product of the red secondary source optical power control value 1505 and the master brightness control value 1501. The red secondary source optical power command 1507 may be for example a binary number corresponding to the selected optical power that is in turn supplied to a digital to analog converter and the resulting voltage used to control the red secondary source lamp power via an adjustable output lamp power supply.

Similarly control 1508 is the optical power control for the green secondary source. This may be a software selected value, adjusted as a percentage of full scale from 0 to 100 percent, that is set to the value determined by the calculations previously described to adjust the chromaticity of the green channel of the display system. This value is processed by multiplier function 1509 which forms the green secondary source optical power command 1510 as the product of the green secondary source optical power control value 1508 and the master brightness control value 1501. The green secondary source optical power command 1510 may be for example a binary number corresponding to the selected optical power that is in turn supplied to a digital to analog converter and the resulting voltage used to control the green secondary source lamp power via an adjustable output lamp power supply.

Similarly control 1511 is the optical power control for the blue secondary source. This may be a software selected value, adjusted as a percentage of full scale from 0 to 100 percent, that is set to the value determined by the calculations previously described to adjust the chromaticity of the blue channel of the display system. This value is processed by multiplier function 1512 which forms the blue secondary source optical power command 1513 as the product of the blue secondary source optical power control value 1511 and the master brightness control value 1501. The blue secondary source optical power command 1513 may be for example a binary number corresponding to the selected optical power that is in turn supplied to a digital to analog converter and the resulting voltage used to control the blue secondary source lamp power via an adjustable output lamp power supply.

The multiplier functions 1503, 1506, 1509 and 1512 cause the master brightness control 1501 to adjust the optical power of all four sources in proportion, maintaining the same relative balance between them as the overall brightness of the display is varied by the master brightness control.

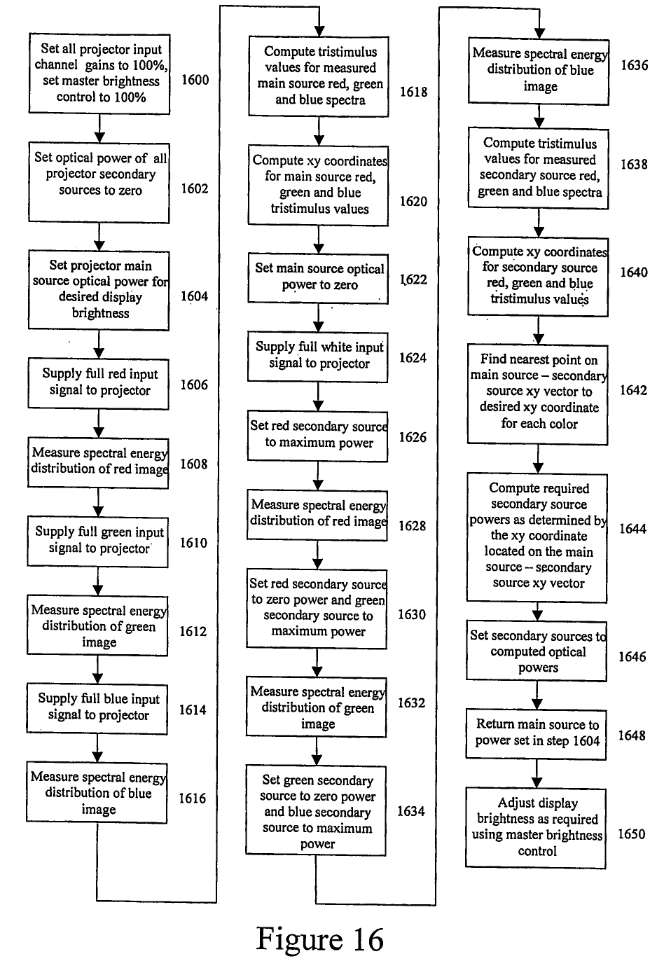

The adjustment of the systems of FIGS. 7, 9 and 10 may be accomplished according to the procedure of FIG. 16. First in step 1600 the input image channel gains are set to maximum (100 percent) for all three input channels, red, green and blue. The master brightness control (1501 in FIG. 15) is also set to full scale (100 percent). The optical power of all three secondary sources is then set to zero at step 1602. Next at step 1604 the projector is supplied with a full white input signal and the optical power of the main illumination source is adjusted to set the desired display brightness. At step 1606 a full red input signal is supplied to the projector so that all pixels of the red image SLM in the projector are driven to full brightness. The spectral energy distribution of the red image is then measured in step 1608. Similarly a full green input signal is supplied to the projector in step 1610, and the spectral energy distribution of the green image is measured in step 1612. Similarly a full blue input signal is supplied to the projector in step 1614, and the spectral energy distribution of the blue image is measured in step 1616. The tristimulus values for the red, green and blue images are then computed using the CE color matching functions in step 1618. The CIE xy values for the red, green and blue primaries are then computed from the tristimulus values in step 1620.

The CIE xy coordinates of the secondary illumination sources are then obtained in steps 1622 through 1640 by setting the main illumination source optical power to zero and then measuring the spectral energy distribution of a full white image illuminated in turn by each of the secondary illumination sources alone and computing the tristimulus values for these spectral energy distributions and converting them to CIE xy coordinates. The vector representing the adjustment range possible for each of the three colors is then the line connecting the CIE xy coordinates of the primaries computed in step 1620 with the CIE xy coordinates of the secondary illumination sources computed in step 1640. Assuming the CIE xy coordinates for the desired primaries are known the required secondary illumination source optical powers may be determined by finding where the shortest line from each of the desired CIE coordinates intersects the vector between the main source chromaticities and the secondary illumination source chromaticities for each primary. The location of the nearest point on the main source—secondary source line to the desired CIE coordinate may be calculated as follows:

$$\begin{matrix}d = \frac{\vert ( C {2}_{y} - C {1}_{y} ) ( C {3}_{x} - C {1}_{x} ) - ( C {2}_{x} - C {1}_{x} ) ( C {3}_{y} - C {1}_{y} ) \vert}{\sqrt{{( C {2}_{x} - C {1}_{x} )}^{2} + {( C {2}_{y} - C {1}_{y} )}^{2}}} & ( 5 ) \\ \vert \vec{C 1 CM} \vert = \sqrt{{\vert \vec{C 1 C 3} \vert}^{2} - {d}^{2}} & ( 6 ) \\ k = \frac{\vert \vec{C 1 CM} \vert}{\vert \vec{C 1 C 2} \vert} & ( 7 ) \\ {CM}_{x} = [ {k}^{*} \vert C {1}_{x} - C {2}_{x} \vert ] + C {1}_{x} & ( 8 ) \\ {CM}_{y} = [ {k}^{*} \vert C {1}_{y} - C {2}_{y} \vert ] + C {1}_{y} & ( 9 )\end{matrix}$$

where:
C1 is the CIE coordinate for the main source primary chromaticity
C2 is the CIE coordinate for the secondary source chromaticity
C3 is the CIE coordinate for the desired primary chromaticity 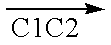
   is the vector between C1 and C2 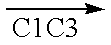
   is the vector between C1 and C3
d is the shortest distance between C3 and 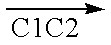 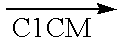
   is the vector along C1 to the perpendicular vector between 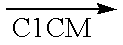
   and C3 with length d
k is the ratio of the length of 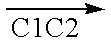
   to the distance between C1 and C2
CM is the CIE coordinate for the point on 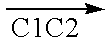
   that is nearest to C3

Once the coordinate CM is known, then the amount of C2 required to form the mixture with C1 that will result in the chromaticity CM may be calculated. The main source optical power will be left at the value set in step 1604, so the amount of the color represented by C1 will be 1, and the amount of C2 may be computed using the following equation:

$$α C 2 = \frac{k}{1 - k} \qquad ( 10 )$$

where:
k is from equation (7) above
αC2 is the amount of the color represented by CIE coordinate C2

These computations are performed in steps 1642 and 1644 in FIG. 16. The secondary source optical powers are then set in step 1646 and in step 1648 the main source is returned to the setting established in step 1604. The brightness is then adjusted in step 1650 using the master brightness control as required to compensate for the additional light from the secondary sources.

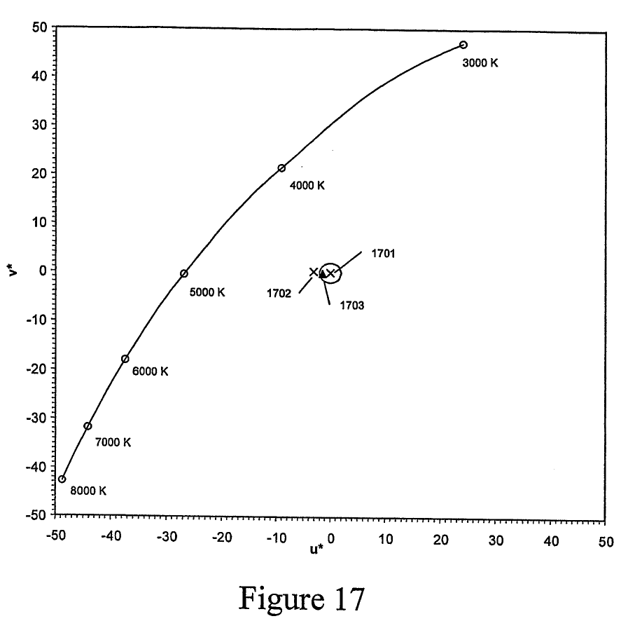

FIG. 17 shows the action of the system of FIG. 7 in adjusting the display gamut for the case of the 6 degree shift shown in FIG. 6. In this case the white point is shifted as shown in FIG. 17 from its original location 1702 to a new location 1703 which is within two delta E units of the reference projector white point 1701. This results in the delta E values for the three primaries and the white point as shown in the following table:

Delta E

| R | G | B | White Point |
|---|---|---|---|
| 2.095151 | 1.971248 | 2.07642 | 1.445626 |

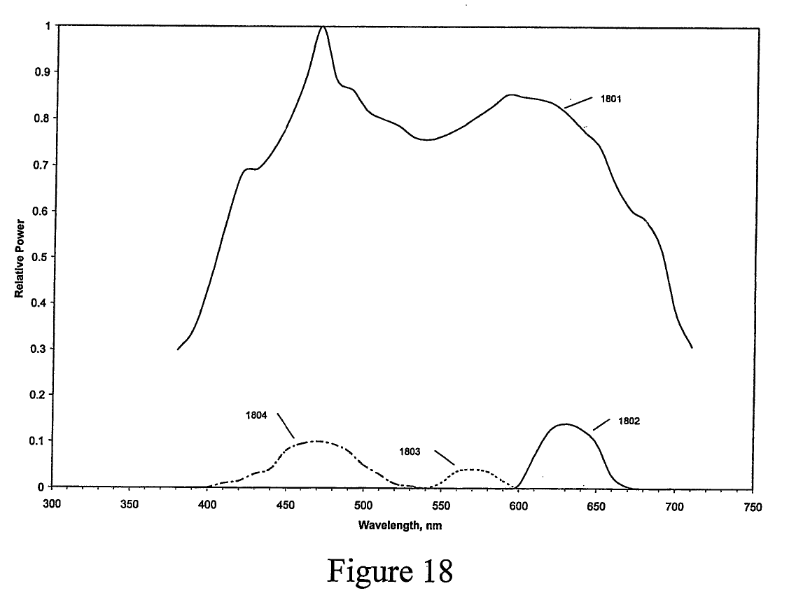

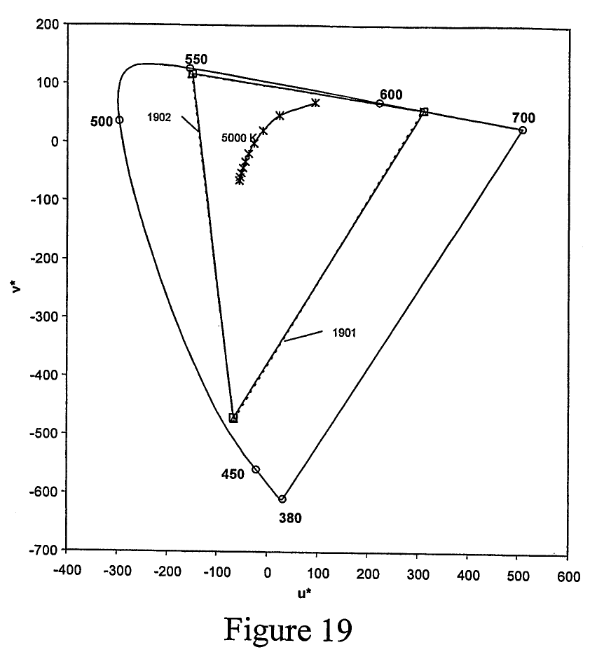

The relative spectral distributions for the main illumination source and the settings of the secondary illumination sources are shown for this example in FIG. 18. The main illumination spectral energy distribution is normalized to 1 and shown as the curve 1801. The secondary illumination spectra are shown at their respective proportional powers as 1802 for red, 1803 for green and 1804 for blue. FIG. 19 shows the resulting restoration of the color gamut location 1902 with respect to the reference color gamut 1901. FIG. 19 shows that the color coordinates of the display primaries have been re-aligned by the addition of the secondary sources in the system of FIG. 7. Consequently the matching of saturated colors is achieved. As discussed above, all SLM based projection systems have a finite and non-zero black level. Because the color balance is achieved prior to the SLM devices, the color match will obtain all the way to the minimum displayable value and to the display black level. This is not true for systems that manipulate color by modifying the input signal since black is the result when no signal is displayed.

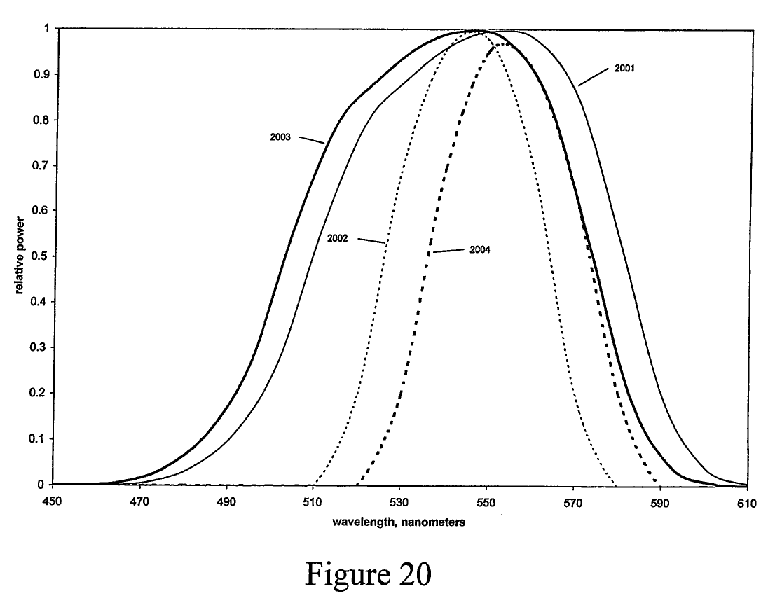

Another embodiment of the systems of FIGS. 7, 9 and 10 incorporates adjustable dichroic filters for each of the secondary illumination sources. In this embodiment the angle of each secondary filter with respect to the incident beam of the secondary illumination source is made adjustable, allowing the resulting spectral energy distribution of each secondary source to be shifted towards longer or shorter wavelengths. FIG. 20 shows the passbands for the green primary and green secondary color filters. The solid line at 2001 indicates the passband of the green primary color filter in the color separating and re-combining device 716 in FIG. 7. The dotted line at 2002 indicates the passband of the green secondary color filter 708 in FIG. 7. The heavy solid line 2003 indicates the shift of the green primary passband when the angle of incidence on this filter is increased by 6 degrees. The heavy dotted line at 2004 shows the result of making a complimentary shift in the angle of incidence on the secondary color filter.

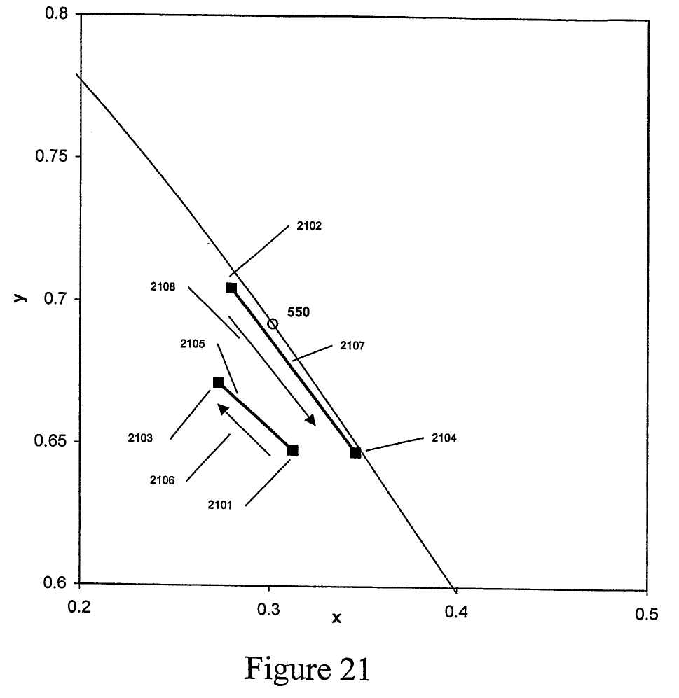

FIG. 21 shows the chromaticity coordinates that result for the primary and secondary sources based on the passbands shown in FIG. 20. The point 2101 corresponds to the passband for the green primary filter shown at 2001 in FIG. 20. The point 2102 corresponds to the passband for the green secondary filter shown at 2002 in FIG. 20. Similarly, the point 2103 corresponds to the passband for the green primary filter with an increase in the angle of incidence of 6 degrees as shown at 2003 in FIG. 20, and point 2104 corresponds to the passband for the green secondary filter when shifted by a complimentary amount as shown by the passband at 2004 in FIG. 20.

In order to move the shifted chromaticity 2103 back towards the unshifted chromaticity 2101, it is necessary for the secondary source to be located at coordinates that represent a passband shifted towards the longer wavelengths. This can be accomplished by adjusting the angle of incidence on the green secondary filter to produce such a shift. This is illustrated in FIG. 21 where the vector 2105 connecting points 2101 and 2103 in FIG. 21 is the line along which the chromaticity of the green primary moves as the angle of incidence on the filter is changed. The arrow 2106 shows the direction that the chromaticity moves as the angle of incidence is increased. Similarly, the vector 2107 connecting points 2102 and 2104 is the line along which the chromaticity of the green secondary moves as the angle of incidence on the filter is changed. The arrow 2108 shows the direction that the chromaticity moves as the angle of incidence is decreased.

The resulting chromaticity of the green channel of the projector will lie somewhere between the vectors 2105 and 2107 of FIG. 21 when the primary and secondary source spectra are mixed. The range of variation and the target chromaticity for the green primary will determine the preferred location of the two vectors as can be appreciated from FIG. 21. It should also be understood that the foregoing are for the purposes of illustration only, the magnitudes of the variations to be corrected in an actual system are not necessarily represented in FIG. 21, but the spirit of the invention carries over into any configuration of primary and secondary spectra and resulting chromaticities that can be realized for the purposes of adjustment of the colors in a projection display.

The systems of FIGS. 7, 9 and 10 are based on conventional arc lamp sources. While screen size and illuminance requirements make the use of a high output source such as a Xenon arc lamp for the main illumination source preferable, the secondary illumination sources could be Xenon or other types of arc lamps as well or alternatively the secondary sources could be incandescent sources, lasers or a light emitting diodes (LEDs). If incandescent sources, lasers or light emitting diode (LED) array sources are used in the systems of FIGS. 7, 9 and 10 suitable changes to the optical configuration of the secondary illumination source lamp and reflector assemblies would be needed as known to those of skill in the art. The use of lasers or LED arrays as secondary sources confers a particular benefit in that these sources provide by direct emission a selected spectral band, corresponding to the red, green or blue portions of the spectrum. Both incandescent and LED sources also offer the advantage of simple direct electronic control of brightness.

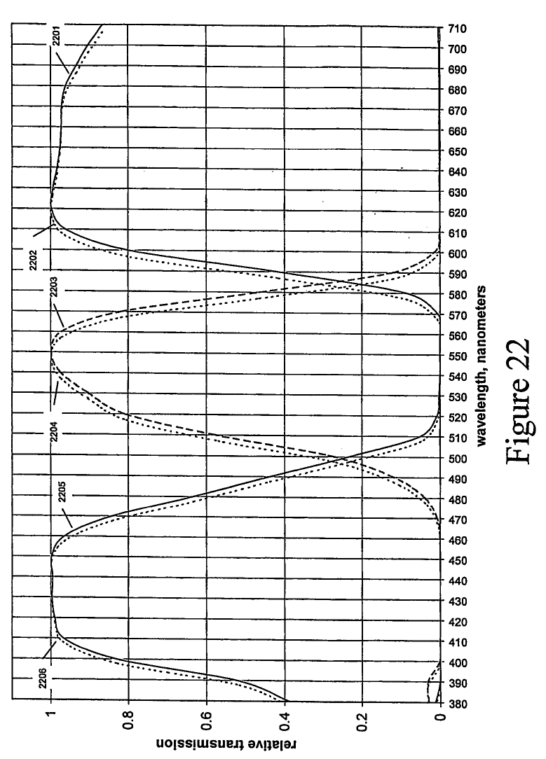

A third alternative configuration is suggested by further consideration of the effect of wavelength shifts as shown by the line 305 in FIG. 3. The effect of these shifts on the passbands of the three filters used in the color separation and re-combining filters used in the system of FIG. 1 is shown in FIG. 22. For example, the reference spectral transmission curve for the red filter is shown at 2201, and the shifted version at 2202. These plots are for shifts due to an increase in the tilt angle of the filters, but similar shifts arise from variations in the thickness of layers in the coating stack of the filter. Similarly, the reference spectral transmission curve for the green filter is shown at 2203, and the shifted version at 2204, and the reference spectral transmission curve for the blue filter is shown at 2205, and the shifted version at 2206. In all cases, the shift is shown as being towards the blue end of the spectrum as would result from increasing the angle of incidence of the light reaching each filter.

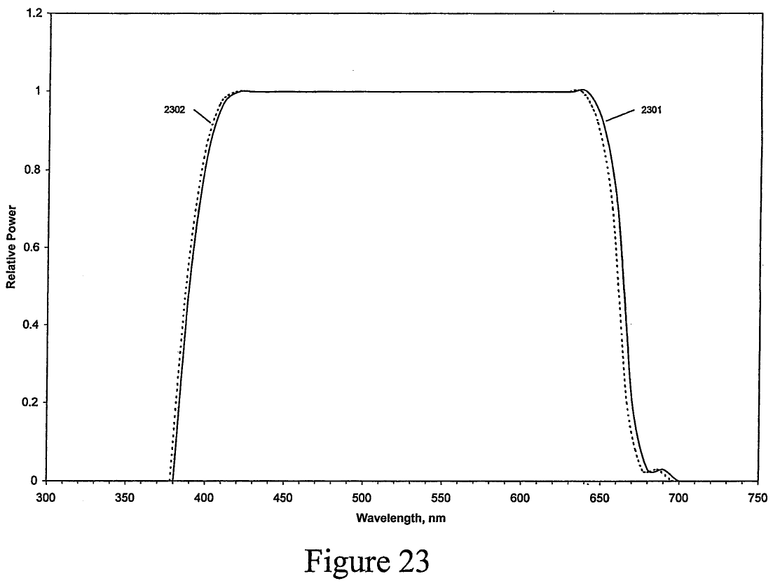

The curve for a bandpass filter is shown in FIG. 23. The reference curve for the spectral transmission of this filter is shown at 2301, and the shifted curve for the spectral transmission of this filter is shown at 2302. This curve shows a similar shift towards the blue end of the spectrum as those shown by the curves in FIG. 22.

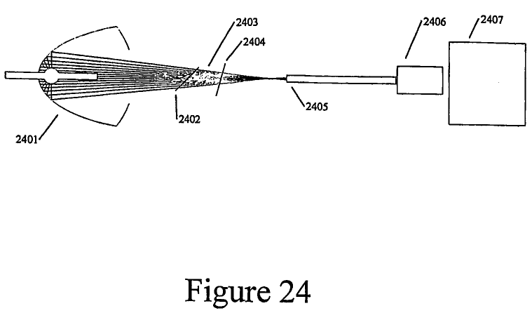

An alternative embodiment for color correction is described with reference to an exemplary embodiment shown in FIG. 24, which forms the illumination system of a projector incorporating the methods of the present invention. Illumination source 2401 consists of a reflector assembly and a high pressure Xenon arc lamp. An elliptical reflector and a spherical retro-reflector combination is shown, but other reflector and lamp combinations may be used and are known to those skilled in the art. The unwanted infrared component of the light from 2401 is removed by selectively reflecting filter 2402. Illuminating light 2403 then passes through adjustable bandpass filter 2404 and then enters illumination integrating bar 2405. The output of integrating bar 2405 is then focused into the desired illumination cone by illumination relay 2406 and then directed into color separating and re-combining device 2407. The color separating and re-combining device 2407 is analogous to the color separating and re-combining device 105 shown in FIG. 1, and the balance of the projection optical system including the SLMs, electronics, and projection lens may be inferred by reference to FIG. 1.

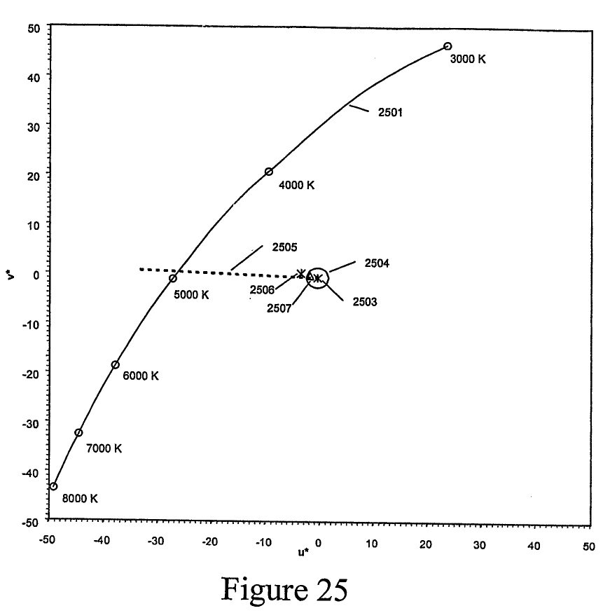

Adjustable bandpass filter 2404 is capable of adjustment in angle with respect to the optical axis (conventionally the θ angle) of the illumination system so that the angle of incidence of light 2403 can be varied. Filter 2404 has bandpass characteristics similar to that shown in FIG. 23. This characteristic varies in the manner shown in FIG. 23 as the tilt angle of this filter is varied with respect to incident light 2403. By adjusting the angle of this filter the bandpass characteristic can be made to cut off more or less of the blue portion of the spectrum of the light entering integrating bar 2405. At the same time, the filter will cut off more or less of the red portion of the spectrum. This adjustment operates for the adjustment of color in a fashion that is similar to that of the system of FIG. 7 as shown by the u*v* diagram of FIG. 25. FIG. 25 is a plot of a region from a diagram similar to FIG. 2 and occupies the same area as the dashed outline at 204 in FIG. 2. At 2501 are the Planckian spectral loci and 2503 is the white point for typical three SLM based projector using DMD devices. The circle 2504 shows the radius of two delta E units of color difference from the white point 2503. The line 2505 shows the direction of color shift for the projector white point caused by a variation in the tilt angle of the illuminating light on the red, green and blue dichroic filters used in the color separating and re-combining device of the projector. The point 2506 shows the shifted white point coordinates of the second projector in the system of FIG. 1, and the point 2507 shows the shifted white point adjusted by the system of FIG. 24.

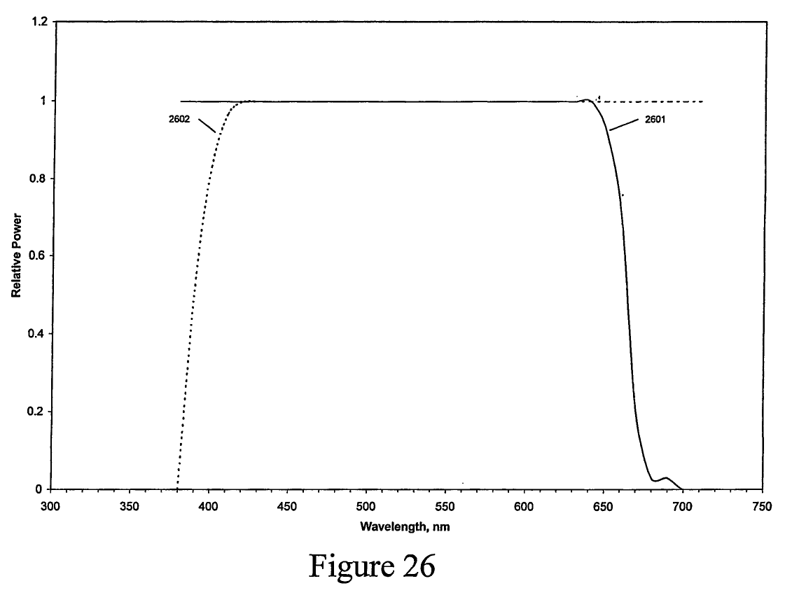

It is also possible to add a second filter capable of adjustment similar to filter 2404. FIG. 26 is an example of the spectral transmission curves that can be used for two adjustable filters in the system of FIG. 24. Filter curve 2601 is for a first high pass filter that adjusts the boundary of the red spectral cut-off for the illuminating light. Filter curve 2602 is a for a second low pass filter that adjusts the boundary of the blue spectral cut-off for the illuminating light. These two filters provide a more flexible adjustment capable of achieving the same benefits as shown in FIG. 25.

The system of FIG. 24 can be adjusted using similar methods to those described in FIG. 16. In this case it is necessary only to determine the tristimulus values of the white point of the projector when the projector is driven by a full white input signal and then to adjust the angle of the filter or filters at 2404 until the desired white point chromaticity is obtained.

So far the discussion of the effects of tilt have been considered to be uniform over the field of illumination. Projectors that employ dichroic filters for color separation and re-combining use illumination system designs that attempt to ensure that all points on each color filter see the same angular distribution. This is done by employing for example an illumination optical system that produces a telecentric image of the source of illumination for the filters in the color separating and re-combining device. With a telecentric configuration the image chief ray angles for all field points are zero and the marginal rays have essentially the same angle for each field point.

A variation in angle of incidence of as little as 6° or ±3° will result in a delta E shift of 3 units, enough to be visible under the conditions where certain embodiments of the present invention will be used. SLM based projectors of the type used in the system of FIG. 1 have been known to exhibit such color shifts, with the overall image area having, for example, a horizontal shift from right to left of three delta E or more, causing one side of the projected image to have an overall blue color cast when compared to the other side. Configuring a system with two projectors, each with opposite color shifts, increases the visibility of the seam between them, which is undesirable.

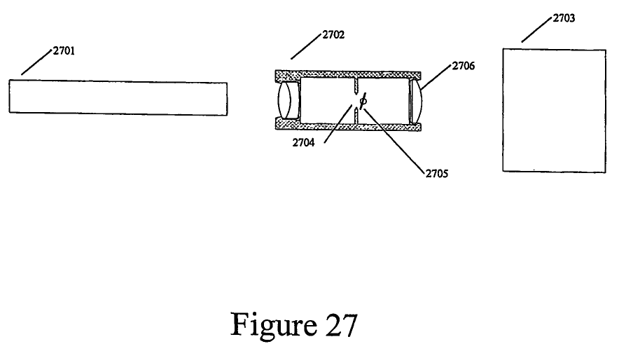

By placing an adjustable bandpass filter, similar to 2404 in FIG. 24 and capable of similar θ angle adjustment, within the illumination relay, for example near the pupil of a telecentric illumination relay, the color shift across the screen may be controlled by adjusting the angle of incidence on the bandpass filter. This is shown in FIG. 27, which corresponds to a portion of the illumination system of FIG. 24. 2701 in FIG. 27 is an illumination integrating bar, which corresponds to 2405 in FIG. 24. The illumination relay 2702 corresponds to 2406 in FIG. 24. 2703 is the color separation and re-combing system, which corresponds to 2407 in FIG. 24. The adjustable bandpass filter is shown at 2705, the telecentric stop of the relay is shown at 2704, and the final lens of the relay at 2706.

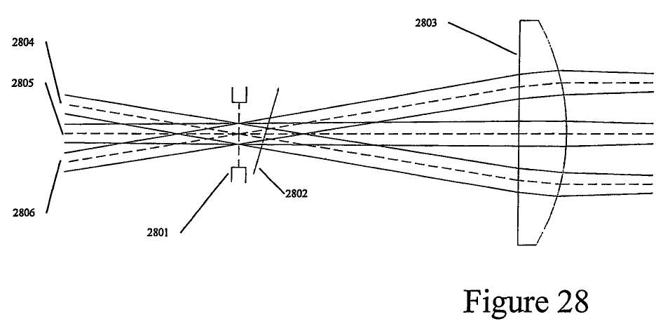

FIG. 28 is a detail of relay 2702, showing the stop at 2801 and the adjustable bandpass filter at 2802. Lens 2803 corresponds to the final relay lens element 2706 in FIG. 27. A ray bundle from an object field point above the optical axis is shown at 2804, with the principle ray shown in a dashed line, and the marginal rays shown in solid lines. Similarly, a ray bundle along the optical axis is shown at 2805, and a ray bundle from an object field point below the optical axis is shown at 2806. As can be seen from FIG. 28 the rays 2804 from a field point above the optical axis strike the adjustable filter 2802 at a more oblique angle than rays at the optical axis 2805 or below the optical axis 2806. This results in a greater wavelength shift for the rays above the optical axis. These rays correspond to one edge of the projector display after the light passes through the color separating and re-combining device and is focused on the projection screen by the projection lens. The rays 2805 correspond to rays to the center of the projector display and the rays 2806 correspond to the opposite edge of the projector display from the rays at 2804. The rays at 2805 and 2806 experience a progressively lesser wavelength shift due to the reduced angle at which they intersect the filter 2802. By proper adjustment of the angle of the filter 2802 a color shift across the display can be compensated by the filter 2802. If the relay or the portion of the relay containing the adjustable filter 2802 is made to rotate about the optical axis, permitting adjustment in the conventional φ direction then the orientation of the color shift correction may be adjusted, for example from horizontal to a diagonal across the display.

The system of FIG. 27 can be adjusted using similar methods to those described in FIG. 16. In this case it is necessary only to determine the tristimulus values of the white point of the projector at opposite edges when the projector is driven by a full white input signal and then to adjust the angle and rotation of the filter at 2705 until the desired match between white point chromaticities at each edge is obtained.

It should be understood that the foregoing is for the purposes of illustration only and the principles of this invention can be applied to a single projector, two or more projectors, and to projectors arranged in configurations where the composite image is produced from a matrix of images arranged horizontally, vertically or both. The invention can also be applied to projectors that do not rely on dichroic filters for the separation and/or recombination of color since the methods of color adjustment are independent the filter types used in the projector for color separation and/or recombination. The present invention is intended to embrace all such alternative configurations, all of which can be implemented without departing from the spirit of the present invention.

1. A projection system having three color channels, one for each primary color, comprising:
a plurality of spatial light modulator (SLM) devices, one for each color channel, each SLM capable of modulating light on a per pixel basis;
a main illumination source capable of producing light;
a plurality of secondary illumination sources each capable of producing light;
a plurality of optical power controlling devices for controlling the flux of light produced by the secondary illumination sources;
an integrating device capable of integrating the light produced by the main illumination source and the secondary illumination sources;
a color separating and re-combining device capable of receiving the integrated light from the integrating device, separating the light into the color channels, directing the light in each color channel to the corresponding SLM, and re-combining the modulated light from each SLM to form an image; and
a projection lens capable of receiving the image from the color separating and re-combining device and projecting the image,
wherein the addition of light from the secondary illumination sources acts to control color variations in the image.

2. The system according to claim 1, wherein the main illumination source and the secondary illumination sources each have an intensity distribution and the intensity distributions of the main illumination source and secondary illumination sources are matched.

3. The system according to claim 1, wherein there is a secondary illumination source for each color channel.

4. The system according to claim 1, wherein the optical power controlling devices are controlled by using secondary optical power control signals.

5. The system according to claim 4, wherein the secondary optical power control signals are computed by determining chromaticities of the primary colors using the main illumination source alone and then determining a required amount of light from each secondary illumination source needed to bring the resultant mixture to a desired chromaticity for each primary color.

6. The system according to claim 4, wherein the secondary optical power control signals are computed by the method comprising:
a) setting input image channel gains to maximum for all three primary color channels;
b) setting the optical power of the secondary illumination sources to zero;
c) supplying a maximum white light optical power from the main illumination source;
d) setting the optical power of the main illumination source to the desired display brightness;
e) supplying a first primary color input so that all the pixels of the first primary color SLM are driven to full brightness to produce a first primary color image;
f) measuring the spectral energy distribution of the first primary color image;
g) repeating steps (e) and (f) for a second primary color input and a third primary color input;
h) computing tristimulus values for the primary color images;
i) computing xy coordinates for the primary color image tristimulus values;
j) setting the optical power of the main illumination source to zero and supplying a full white input to the projector so that all pixels of all SLM devices are driven to full brightness to produce a full white image;
k) setting the first secondary illuminating source alone to maximum power to produce a first secondary color image;
l) measuring a spectral energy distribution of the first secondary color image;
m) repeating steps (k) and (l) for a second secondary illuminating source and a third secondary illuminating source;
n) computing tristimulus values for the secondary color images;
o) computing xy coordinates for the secondary color image tristimulus values;
p) finding on a first primary-secondary color vector between the first primary color image xy coordinate and first secondary color image xy coordinate a first xy coordinate that is closest to a first desired display primary color xy coordinate;
q) computing a first secondary optical power control signal for the first secondary illumination source to produce the color corresponding to the first xy coordinate found in step (p);
r) repeating step (p) for a second primary-secondary color vector between the second primary color image xy coordinate and the second secondary color image xy coordinate for an xy coordinate that is closest to a second desired display primary color xy coordinate and a third primary-secondary color vector between the third primary color image xy coordinate and the third secondary color image xy coordinate for an xy coordinate that is closest to a third desired display primary color xy coordinate; and
s) repeating step (q) to compute a second secondary optical power control signal for the second secondary illumination source and a third secondary optical power control signal for the third secondary illumination source.

7. The system of claim 6, wherein the method for setting the secondary optical power control signals further comprises:
a) setting the secondary illumination sources to optical powers based on the secondary optical power control signals;
b) supply a full white input signal; and
c) adjusting the overall display brightness as required.

8. The system of claim 6, wherein the secondary optical power control signals determined in steps (p) and (q) are computed by the formulas:
$$d = \frac{\vert ( C {2}_{y} - C {1}_{y} ) ( C {3}_{x} - C {1}_{x} ) - ( C {2}_{x} - C {1}_{x} ) ( C {3}_{y} - C {1}_{y} ) \vert}{\sqrt{{( C {2}_{x} - C {1}_{x} )}^{2} + {( C {2}_{y} - C {1}_{y} )}^{2}}} ;$$
$$\vert \vec{C 1 CM} \vert = \sqrt{{\vert \vec{C 1 C 3} \vert}^{2} - {d}^{2}} ;$$
$$k = \frac{\vert \vec{C 1 CM} \vert}{\vert \vec{C 1 C 2} \vert} ;$$
$${CM}_{x} = [ {k}^{*} \vert C {1}_{x} - C {2}_{x} \vert ] + C {1}_{x}$$
$${CM}_{y} = [ {k}^{*} \vert C {1}_{y} - C {2}_{y} \vert ] + C {1}_{y} ; and$$
$$α C 2 = \frac{k}{1 - k} ,$$
where:
C1 is the xy coordinate for the main source primary chromaticity
C2 is the xy coordinate for the secondary source chromaticity
C3 is the xy coordinate for the desired primary chromaticity 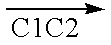
is the vector between C1 and C2 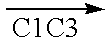
is the vector between C1 and C3
d is the shortest distance between C3 and 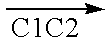 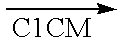
is the vector along C1 to the perpendicular vector between 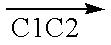
and C3 with length d
k is the ratio of the length of 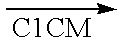
to the distance between C1 and C2
CM is the xy coordinate for the point on 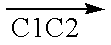
that is nearest to C3
αC2 is the amount of the color represented by xy coordinate C2

9. The system of claim 7, wherein the overall display brightness is adjusted using a master brightness control circuit.

10. The system of claim 9, wherein the master brightness control circuit comprises:
a master brightness control value;
a main illumination source optical power control value;
a main multiplier that calculates a main illumination source optical power command value from a product of the master brightness control value and the main illumination source power control value;
a first secondary illumination source power control value;
a first multiplier that calculates a first secondary illumination source optical power command value from a product of the master brightness control value and the first secondary illumination source power control value;
a second secondary illumination source power control value;
a second multiplier that calculates a second secondary illumination source optical power command value from a product of the master brightness control value and the second secondary illumination source power control value;
a third secondary illumination source power control value; and
a third multiplier that calculates a third secondary illumination source optical power command value from a product of the master brightness control value and the third secondary illumination source power control value.

11. The system of claim 1, wherein each secondary illumination source has an associated adjustable dichroic filter, where the adjustable dichroic filters are capable of adjustment to change the angle of incidence with the respective secondary illumination source in order to adjust color variations in the image.

12. The system according to claim 1, further comprising a light mixing system for focusing the light produced by the main illumination source and the secondary illumination sources into the integrating device.

13. The system of claim 1 wherein the main and secondary illumination sources are lamps.

14. The system of claim 1 wherein each secondary illumination source comprises a wavelength selecting filter.

15. The system of claim 1 wherein the main and secondary illumination sources are incandescent sources.

16. The system of claim 1 wherein the main and secondary illumination sources are light emitting diode (LED) array sources.

17. The system of claim 1 wherein the secondary illumination sources are lasers.

18. The system of claim 1, wherein the system is used in a multiple projection system and the image of the system is combined with at least one other image to form a composite image.

19. In a projection system capable of producing a color image, the projection system having a spatial light modulator (SLM) for each of three color channels, one for each primary color, a method for adjusting the color of the image, the method comprising:
providing light having a spectral energy distribution from at least one illumination source to a separating and re-combining device;
controlling the spectral energy distribution of the light entering into the color separating and re-combining device without reducing the overall brightness of the image;
modulating the controlled light with at least one spatial light modulator (SLM) to form an image; and
projecting the image.

20. The method according to claim 19, wherein the illumination source comprises a main illumination source and at least one secondary illumination source and the spectral energy distribution is controlled by adding light from at least one secondary illumination source.

21. The method according to claim 20, wherein the amount of added light from the secondary illumination source is computed by determining the chromaticities of the primary colors using the main illumination source alone and then determining the required amount of light from the secondary illumination source needed to bring the resultant mixture to a desired chromaticity for each primary color.

22. The method according to claim 19, wherein there are three secondary illumination sources, one for each color channel.

23. The method according to claim 21, wherein the spectral energy distribution of the total illumination is controlled by controlling an optical power of light from each secondary illumination source to achieve a desired chromaticity for each primary color.

24. The method according to claim 20, wherein each secondary source has an associated adjustable dichroic filter allowing a resulting spectral energy distribution of each secondary source to be shifted toward longer or shorter wavelengths.

25. The method according to claim 19, wherein the spectral energy distribution is controlled by an adjustable bandpass filter in between the illumination source and the separating and re-combining device, wherein the adjustable bandpass filter is capable of controlling the color spectrum so that the amount of each primary color in the light entering the separating and re-combining device is controlled.

26. The method according to claim 25, wherein the amount of each primary color in the light entering the separating and re-combining device is computed by determining the chromaticities of the primary colors with the adjustable bandpass filter in a neutral position and then adjusting the bandpass filter to bring the resultant mixture to a desired chromaticity for each primary color.

27. The method of claim 19, wherein the projection system is used in a multiple projection system and the image produced by the system is combined with at least one other image produced by at least one other system to form a composite image.

28. A projection system having three color channels, one for each primary color, comprising:
a plurality of SLM devices, one for each color channel;
an illumination source capable of producing light;
a first adjustable bandpass filter capable of controlling the spectral energy distribution of light in at least one color channel;
an integrating device capable of integrating the light produced by the illumination source as filtered by the first adjustable bandpass filter;
a color separating and re-combining device capable of receiving the integrated light from the integrating device, separating the light into the color channels, directing the light in each color channel to the corresponding SLM, and re-combining the modulated light from each SLM to form an image; and
a projection lens capable of receiving the image from the color separating and re-combining device projecting the image,
wherein adjustment of the first adjustable bandpass filter acts to control color variations in the image.

29. The system according to claim 28, wherein the adjustment of the first adjustable bandpass filter is computed by determining the chromaticities of the primary colors with the first adjustable bandpass filter in a neutral position and then determining an angle for the first adjustable bandpass filter in order to achieve the required amount of light of each primary color needed to bring the resultant mixture to a desired chromaticity for each primary color.

30. The system according to claim 28, further comprising a second adjustable bandpass filter capable of controlling the amount of light in at least one color channel, wherein adjustment of the first and second adjustable bandpass filters acts to control color variations in the image.

31. The system according to claim 30, wherein the adjustment of the first and second adjustable bandpass filters is computed by determining the chromaticities of the primary colors with the first and second adjustable bandpass filters in a neutral position and then determining an angle for the first adjustable bandpass filter and an angle for the second adjustable bandpass filter in order to achieve a required amount of light of each primary color needed to bring the resultant mixture to a desired chromaticity for each primary color.

32. The system according to claim 28, further comprising an illumination relay, the relay positioned in the light path between the integrating device and the separating and re-combining device, wherein the first adjustable bandpass filter is positioned within the relay.

33. The system according to claim 28, wherein the projection system is used in a multiple projection system and the image produced by the system is combined with at least one other image produced by other system to form a composite image.

34. A projection system having three color channels, one for each primary color, comprising:
a plurality of SLM devices, one for each color channel, each SLM capable of modulating light;
three illumination sources capable of producing light, wherein there is one illumination source for each color channel;
a plurality of optical power controlling devices for controlling the flux of light produced by the illumination sources;
an integrating device capable of integrating the light produced by the illumination sources;
a color separating and re-combining device capable of receiving the integrated light, having a spectral energy distribution, from the integrating device, separating the light into the color channels, directing the light in each color channel to the corresponding SLM, and re-combining the modulated light from each SLM, to form an image; and
a projection lens capable of receiving the image from the color separating and re-combining device and projecting the image,
wherein the spectral energy distribution of the light entering into the separating and re-combining device is controlled to control color variation of the image.

35. The system according to claim 34, wherein the spectral energy distribution is controlled by controlling the optical power of light from each illumination source to achieve a desired chromaticity for each primary color.

36. The system according to claim 34, wherein each illumination source has an associated adjustable dichroic filter allowing the resulting spectral energy distribution of each illumination source to be shifted toward longer or shorter wavelengths.

37. The system according to claim 34, wherein the projection system is used in a multiple projection system and the image produced by the system is combined with at least one other image produced by at least one other system to form a composite image.

38. The method according to claim 22, wherein each secondary source has an associated adjustable dichroic filter allowing a resulting spectral energy distribution of each secondary source to be shifted toward longer or shorter wavelengths
